(19) United States
(12) Patent Application Publication
(10) Pub. No.: US 2026/0320685 A1
(43) Pub. Date: Oct. 15, 2026

(54) STOCK FILTER FOR TARGETTING A SMALL LIST OF LIKELY FAVORABLE STOCKS

(71) Applicant: Hans P. Hansen, Garwood, NJ (US)

(72) Inventor: Hans P. Hansen, Garwood, NJ (US)

(21) Appl. No.: 19/440,721

(22) Filed: Jan. 6, 2026

Related U.S. Application Data
(63) Continuation-in-part of application No. 19/196,764, filed on May 2, 2025, now Pat. No. 12,536,591.
(60) Provisional application No. 63/641,422, filed on May 2, 2024.

(51) Int. Cl. G06Q 40/04

(52) U.S. Cl. CPC G06Q 40/042

(57) ABSTRACT

A computer-implemented system and method for filtering, ranking, and visualizing stock symbol lists for targeted trading is disclosed. A computing system retrieves multiple predefined stock symbol lists and executes a primary filtering process to generate post-filtered subsets of symbols satisfying selection criteria based on price and/or volume characteristics. The system computes aggregate performance metrics for each subset over multiple trading days and ranks the symbol lists using a stored algorithm. A graphical user interface presents the ranked lists along with visual distribution plots, enabling user evaluation. Technical benefits include reduced processor load, memory usage, and graphical rendering by eliminating underperforming symbol lists prior to visualization or interaction. The system optionally includes a backtest module and visual summary features to evaluate historical performance trends. Data compression and display optimization techniques improve system responsiveness and reduce interface latency, supporting faster decision-making in data-intensive financial environments.

### CROSS-REFERENCE TO RELATED APPLICATIONS

The present application is a U.S. Continuation-In-Part Patent Application entitled, “STOCK FILTER FOR TARGETTING A SMALL LIST OF LIKELY FAVORABLE STOCKS” which claims priority to co-pending U.S. Utility patent application Ser. No. 19/196,764, filed on May 2, 2025 entitled, “STOCK FILTER FOR TARGETTING A SMALL LIST OF LIKELY FAVORABLE STOCKS” which claims benefit of provisional 63/641,422, filed on May 2, 2024 entitled, “STOCK FILTER FOR TARGETTING A SMALL LIST OF LIKELY FAVORABLE STOCKS” the contents of which are hereby fully incorporated by reference.

### FIELD

The field of the invention and its embodiments relate to financial stock transactions and more specifically to a stock filter for targeting a small list of likely favorable stocks.

### BACKGROUND

As volatility in trading markets have increased over the years, a long term buy and hold strategy has become increasingly risky. That is, the gains achieved by such a strategy has increasingly diminished since 1971. Thus, a buy and hold consumer has increasing experienced diminishing returns compared to reliance on other, more dynamic strategies. These more dynamic strategies, however, are often thought to be overly complex, so much so that they fall into an exclusive realm of trained professionals.

That is, trading challenges, undoubtedly the cornerstone of every trader's journey, present a myriad of obstacles to conquer. These trading challenges encompass a wide range of factors, testing the mettle of even the most seasoned professionals. With the fast-paced and ever-changing nature of the financial markets, professionals to novices experience largely the same challenges, which can be successfully navigated; at least to an extent to extend performance over the increasingly less optimal buy and hold baseline.

Volatility, often believed to be the foremost among the trading challenges, introduces a sense of urgency and opportunity. Market fluctuations demand traders to remain poised and make swift, well-informed decisions to capitalize on potential gains while mitigating risks. The ability to manage risk effectively, another challenge, safeguards traders' capital and fosters long-term profitability. Volatility means that dynamic strategies must be deployed, as the market is constantly adjusting and reoptimizing. In fact, the academic theory of an efficient market presumes the market will always automatically adjust to near optimal conditions, after a relatively short lag period. This leads many traders to believe that information dominance, having superior information on underlying stocks to the “market” is necessary to achieve the best consistent results. The various theories on specific mechanisms for doing so are almost as vast as the stars in the universe and are often highly guarded secrets.

Information overload poses significant trading challenges in the digital era, where an abundance of data floods the financial markets. Traders must develop the skills to sift through this vast sea of information, extracting relevant insights that inform their trading decisions. This skill enables them to stay ahead of the curve and make well-calibrated moves. Some have come to rely on increasingly complex tools, such as artificial intelligence to shift through truly overwhelming realms of data to beat the general principle of market efficiency. The increased use of powerful information shorting and processing tools leaves many to believe that human beings with limited resources are increasing becoming disadvantaged in the stock market.

What is needed is a way to quickly filter a vast set of stocks and related information into a relatively modest set of stocks, which can be simultaneously monitored on a daily basis to a trader's advantage. Ideally, such a filtering of stocks will be dynamic so that it effectively is self-adjusting to target an optimal set of stocks.

### SUMMARY OF THE EMBODIMENTS

The present invention and its embodiments relate to a program and method to analyze the performance of prior day trading stocks in order to identify a small list of stocks with a high probability of having a substantially greater closing price than the lowest price experienced during the training session. Basically, stocks sought are those with deep nulls or valleys and high peaks. An initial unfiltered set of stocks can be extracted from a combination of one or more daily lists, such as the daily list provided by INVESTOR's BUSINESS DAILY (IBD) and/or the ASSOCIATION OF CHARTERED CERTIFIED ACCOUNTANTS (ACCA). An initial unfiltered set will typically have more than one hundred unique stocks. The unfiltered set is run through a primary filter, which may have multiple sub-steps and sub-filters. In one embodiment, the primary filter can include a first filter that filters out all unique stocks with a moving average trading volume less than or equal to a first sub-filter threshold of shares, such as 800,000 shares. A second sub-filter is a performance filter and a third filter can be a ranking filter. The primary filter contains a small set, such as five, of unique stocks with a very high likelihood of having an average (close-low) percentage change greater than three (3) percent(%). The resulting set of five stocks, or another configurable number referred to as the primary quantity, are able to be displayed simultaneously and updated throughout a given trading day. In one embodiment, the displaying can recurringly update for each unique stock, its percentage change from low, its percentage change from high, and provide other relevant dynamic data and charts.

In some aspects, the techniques described herein relate to a computer-implemented method for identifying high-performing stock symbol lists for targeted trading, the method including: retrieving, by a computing system including at least one processor, a non-transitory memory, and a graphical user interface, one or more predefined stock symbol lists, each predefined stock symbol list including a set of unique stock identifiers; for each of the one or more predefined stock symbol lists, executing, by the at least one processor, a primary filtering process to generate a corresponding post-filtered subset of stock symbols that satisfy one or more predefined selection criteria based on price and/or volume characteristics; computing, by the at least one processor, one or more aggregate performance metrics for each post-filtered subset over a plurality of trading days; ranking, by the at least one processor, the one or more predefined stock symbol lists based on the aggregate performance metrics using a stored ranking algorithm; and displaying, via the graphical user interface, a ranked set of the predefined stock symbol lists with corresponding visual representations of performance distributions, wherein the method improves computing system performance by reducing processor load, memory usage, and display rendering operations through automated exclusion of underperforming symbol lists prior to visualization or user interaction, wherein ranking the one or more predefined symbol lists using the performance metrics facilitates dimensionality reduction and early-stage pruning, thereby optimizing CPU thread allocation and cache usage during batch filtering operations.

In some aspects, the techniques described herein relate to a system for filtering, ranking, and displaying high-performing stock symbol lists for trading, the system including: a data interface configured to retrieve price and volume data for a plurality of stock symbols from one or more external data sources; a non-transitory memory storing: a plurality of predefined stock symbol lists, each including unique stock identifiers, one or more selection criteria, and program instructions for filtering and ranking operations; at least one processor configured to execute the program instructions to: apply a primary filtering operation to each of the predefined stock symbol lists to generate a corresponding post-filtered subset; compute aggregate performance metrics for each of the post-filtered subsets; rank the predefined stock symbol lists based on the aggregate performance metrics; and generate display data including visualizations of the ranked predefined stock symbol lists; and a graphical user interface configured to render the display data for user review, wherein the system reduces unnecessary data processing and graphical rendering overhead by excluding underperforming symbol lists prior to output generation.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1A depicts a block diagram to acquire and filter a set of stocks, in accordance with embodiments of the present invention.

FIG. 1B depicts a block diagram for performance filtering a set of stocks, in accordance with embodiments of the present invention.

FIG. 1C depicts a block diagram for rank filtering a set of stocks, in accordance with embodiments of the present invention.

FIG. 2A provides a detailed diagram for an embodiment of creating small listings having the primary quantity (e.g., 5) number of stocks of interest, in accordance with embodiments of the present invention.

FIG. 2B provides a stepwise diagram for an embodiment of creating small listing of stocks of interest, in accordance with embodiments of the present invention.

FIG. 2C-2K provide a set of flow charts for filtering stocks, in accordance with embodiments of the present invention.

FIG. 2L depicts a display screen for stock monitoring, tracking, and filtering, in accordance with embodiments of the present invention.

FIG. 3 depicts a block diagram of a set of computing devices referenced in FIG. 1A, in accordance with embodiments of the present invention.

FIG. 4 is a flowchart illustrating a method for targeted stock monitoring and trading, according to some embodiments of the present disclosure.

FIG. 5 is a flowchart further illustrating the method for targeted stock monitoring and trading from FIG. 4, according to some embodiments of the present disclosure.

FIG. 6 is a flowchart illustrating a method for targeted stock monitoring and trading, according to some embodiments of the present disclosure.

FIG. 7 is a flowchart illustrating a method for targeted stock monitoring and trading, according to some embodiments of the present disclosure.

FIGS. 8A, 8B, and 8C are flowcharts illustrating a computer-implemented method for identifying high-performing stock symbol lists for targeted trading, according to some embodiments of the present disclosure.

FIG. 9 is a block diagram illustrating a system, according to some embodiments of the present disclosure.

FIG. 10 is an illustration of an example grid comparing the average daily performance of various predefined stock symbol lists based on the percentage change from closing price to low price (% Ch(C-L)) for selected trading days during the year 2025, according to some embodiments of the present disclosure.

FIGS. 11A and 11B illustrate example bar and cumulative line plots corresponding to the distribution of filtered list performance results for selected trading days, based on percentage changes between daily close and low stock prices (Close-Low %), according to some embodiments of the present disclosure.

FIG. 12 illustrates an example graphical display in which cumulative performance plots for multiple filtered stock symbol lists are simultaneously displayed on a single visual interface to enable comparative evaluation of relative list performance across a plurality of trading days, according to some embodiments of the present disclosure.

FIG. 13 illustrates a stepwise filtering table showing performance improvements of a primary filtering process applied to a symbol list, according to some embodiments of the present disclosure.

FIG. 14 is a chart illustrating symbol performance as identified by a Primary Filter on Oct. 3, 2025, showing time-based symbol closing price trends for a single symbol derived from the AccA symbol list and the RSGt20Le30 list, plotted with multiple moving averages, according to some embodiments of the present disclosure.

FIG. 15 illustrates a performance log view showing the results of Primary Filtering applied to the RsGt20Le40 symbol set, according to some embodiments of the present disclosure.

FIG. 16 is a graphical plot illustrating the intraday performance of a symbol identified through a filtering process applied to the RsGt20Le40 symbol list, showing minute-by-minute closing prices and corresponding moving averages on Oct. 3, 2025, according to some embodiments of the present disclosure.

FIG. 17 is a graphical plot illustrating the intraday performance of a symbol, HQY, identified through a filtering process applied to a trading symbol list, showing minute-by-minute closing prices and associated moving averages on Oct. 3, 2025, according to some embodiments of the present disclosure.

FIG. 18 is a graphical plot illustrating the intraday performance of a symbol, ILMN, selected through a filtering process applied to a candidate symbol list. The figure displays minute-by-minute closing prices alongside 5-minute, 10-minute, and 20-minute moving averages as of Oct. 3, 2025, according to some embodiments of the present disclosure.

FIG. 19 is a graphical chart illustrating intraday performance for the symbol PEG, identified from a filtered subset of the RsGt20Le40 symbol set, including minute-by-minute symbol closing prices and associated moving averages, plotted for Oct. 3, 2025, according to some embodiments of the present disclosure.

FIG. 20 is a graphical representation of the intraday price performance for a symbol selected via the RsGt20Le40 symbol list and associated Primary Filter processing, showing closing price movement and multiple moving averages for TMUS on Oct. 3, 2025, according to some embodiments of the present disclosure.

FIG. 21 is a spreadsheet-style data visualization illustrating the average percentage change from close to low price for multiple symbol lists that have undergone Primary Filtering, according to some embodiments of the present disclosure.

FIG. 22 illustrates an interface form and chart display environment used for automated evaluation of symbol list combinations processed via Primary Filtering, according to some embodiments of the present disclosure.

FIG. 23 illustrates comparative tabular data sets analyzing the performance of symbol filtering techniques, according to some embodiments of the present disclosure.

FIG. 24 illustrates an example screenshot of a user interface generated by a system configured to execute Primary Filtering operations across multiple symbol lists, displaying the resulting candidate trading symbols for a specific trading day, according to some embodiments of the present disclosure.

### DETAILED DESCRIPTION

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, an “embodiment” means that a particular feature, structure or characteristic is included in at least one or more manifestations, examples, or implementations of this invention. Furthermore, the particular features, structures or characteristics may be combined in any suitable manner, as would be apparent to a person having ordinary skill in the art. Combinations of features of different embodiments are meant to be within the scope of the invention, without the need for explicitly describing every possible permutation by example. Thus, any of the claimed embodiments can be used in any combination.

The phrase “and/or,” as used herein in the specification and in the claims, should be understood to mean “either or both” of the elements so conjoined, e.g., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements), etc.

As used herein, the word “include,” and its variants, is intended to be non-limiting, such that recitation of items in a list is not to the exclusion of other like items that may also be useful in the compositions and methods of this technology. Similarly, the terms “can” and “may” and their variants are intended to be non-limiting, such that recitation that an embodiment can or may comprise certain elements or features does not exclude other embodiments of the present technology that do not contain those elements or features.

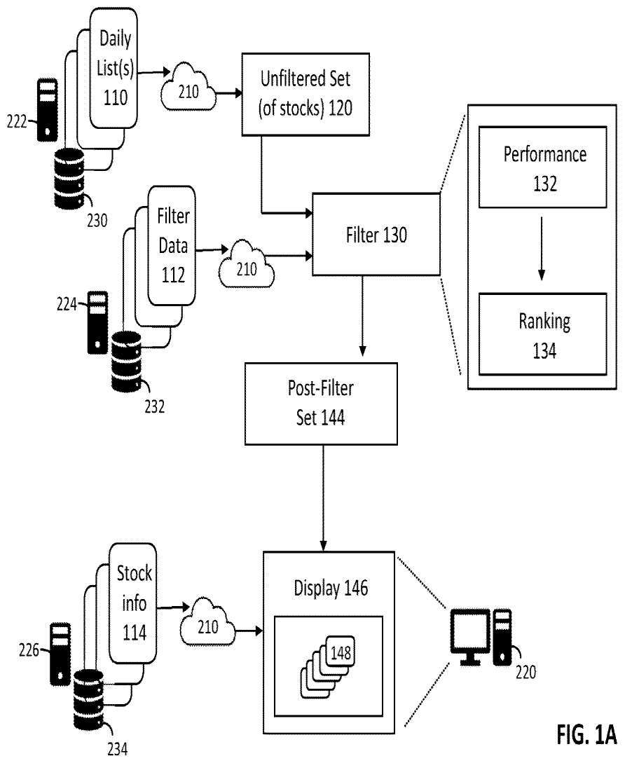

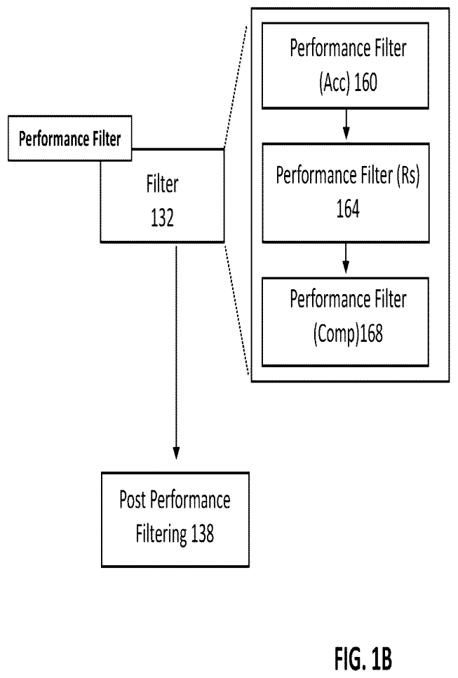

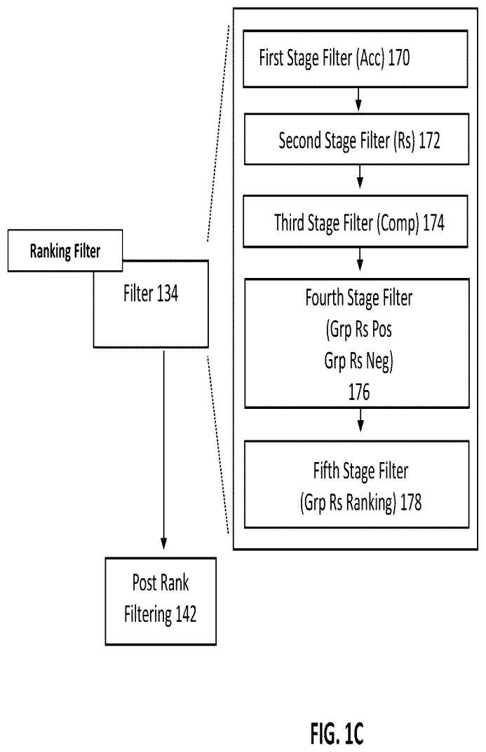

FIGS. 1-24 illustrate example systems and methods for targeted stock monitoring, filtering, and trading decision support. The systems and methods begin by establishing an unfiltered set of one or more stocks of interest, wherein each stock is associated with a unique stock identifier and related stock-specific data, such as daily high, low, close prices, and trading volume. This initial unfiltered set may incorporate additional computed data, such as a fifty-day moving average of shares traded daily, to support preliminary eligibility assessments.

The unfiltered set is then processed through a primary filtering operation, where a primary filter selects stocks that meet specific performance metrics, such as minimum trading volume thresholds and minimum percentage changes from daily lows or highs. This primary filtering stage generates a post-primary-filtered stock set with a limited number of stocks, referred to as a primary quantity, intended to highlight a concise, high-interest list for the user. Following the primary filtering, the systems and methods apply additional layers of refinement using sub-filters. A first sub-filter generates a post-first-filter subset, a second sub-filter further reduces the subset to a post-second-filter subset, and a third sub-filter produces a post-third-filter subset. These sub-filters may incorporate progressively stricter or different criteria, such as recent price performance, ranking metrics, or composite technical indicators, enabling a multi-stage selection process that adapts to varying market conditions and user preferences.

The resulting filtered stock set is then displayed simultaneously to users for a given trading day, allowing for efficient side-by-side comparison and tracking. Furthermore, the systems and methods enable simultaneous and recurring display of key performance updates for each stock in the post-primary-filtered stock set, such as real-time or periodically refreshed percentage changes from daily lows and highs. By automating the filtering, ranking, and updating processes, the systems and methods illustrated in FIGS. 1-4 provide an intelligent and dynamic framework for narrowing a broad universe of stocks into a focused, actionable set that aligns with user-defined or system-optimized trading criteria. This approach enhances decision-making efficiency and supports timely, data-driven trading activities.

The disclosed systems and methods provide specific technical solutions to technical problems associated with real-time stock monitoring and filtering, moving beyond generic computer implementation. Traditional stock tracking tools often overwhelm users with large volumes of unprioritized data, leading to inefficiencies in analysis and decision-making. In contrast, the present disclosure introduces a structured, multi-stage filtering architecture that systematically reduces an unfiltered set of stocks through primary and secondary sub-filters based on non-conventional criteria, such as dynamically computed average close-to-low percentages, volume-based eligibility tied to fifty-day moving averages, and intersectional ranking parameters derived from historical performance metrics. These filtering processes are not merely mathematical concepts or mental processes performed on a general-purpose computer; instead, they are tightly integrated into a specialized stock evaluation framework that operates in real time and dynamically updates based on incoming market data. Moreover, the system simultaneously and recurringly displays one or more performance metrics, such as percentage changes from highs and lows, for a filtered, targeted set of stocks, using data aggregation techniques specifically optimized for stock tracking environments. Collectively, these additional elements provide significant improvements to the functioning of stock monitoring systems themselves, offering concrete technological benefits including reduced computational load, more efficient resource utilization in data display and updating, and improved user interaction by delivering actionable, focused information rather than requiring manual sifting through unfiltered stock lists. Thus, the claimed features represent meaningful improvements in the field of stock monitoring systems and solve specific technical problems that are rooted in technological challenges, rather than merely automating routine human activity using a conventional computer.

Referring to FIG. 1A, a system is shown to acquire and filter a set of stocks, in accordance with embodiments of the present invention. An initial unfiltered set of stocks 120 is created by accessing one or more daily lists. The lists 110 may be publicly available over from an online source and accessible over network 210. Lists 110 can be stored in a data store 230, which is controlled by a server or other computing device 222. In one embodiment, one of the lists 110 can be an INVESTOR'S BUSINESS DAILY (IBD) list or a daily stock list provided by the ASSOCIATION OF CHARTERED CERTIFIED ACCOUNTANTS (ACCA). In a further embodiment, the unfiltered list can be a mathematical intersection of unique stocks contained in both the IBD and ACCA daily lists. Other set of operations can be formed to join a set of multiple daily lists 110 to create the unfiltered set 120. Further other sources can be used for the daily lists 110, which provide their own unique advantages.

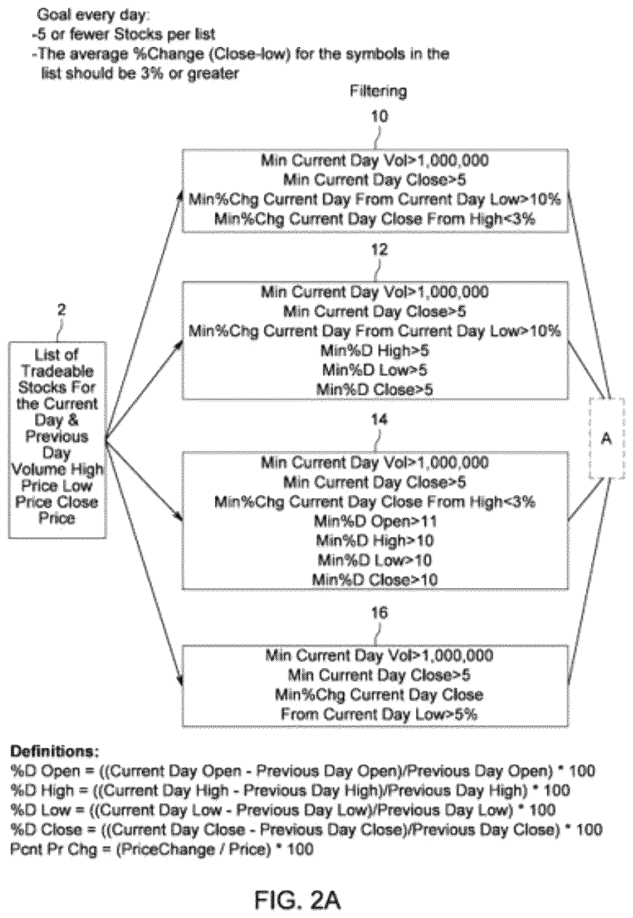

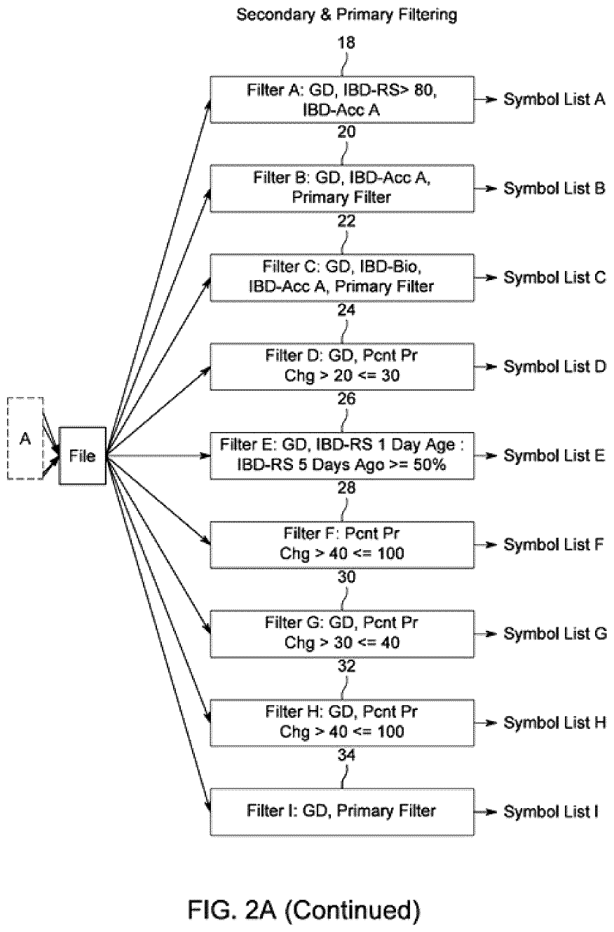

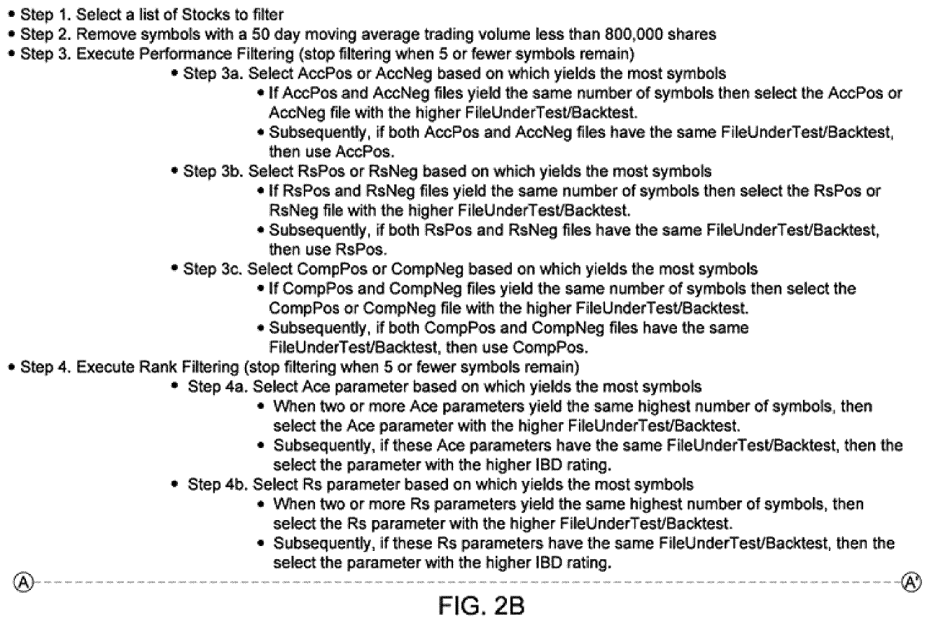

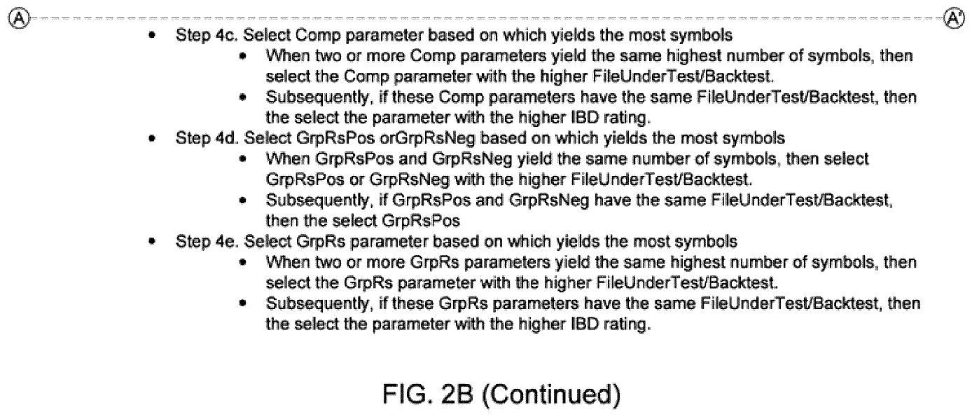

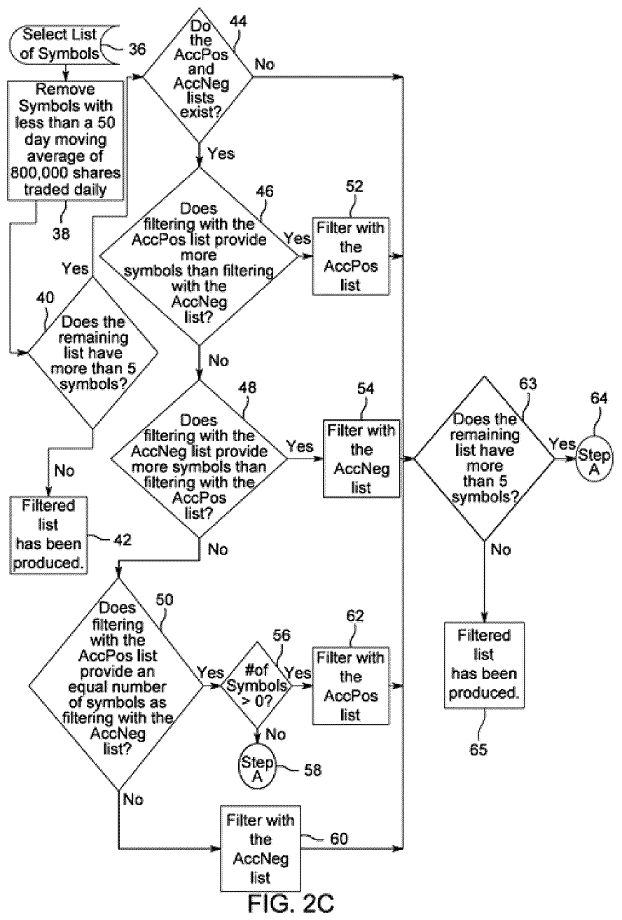

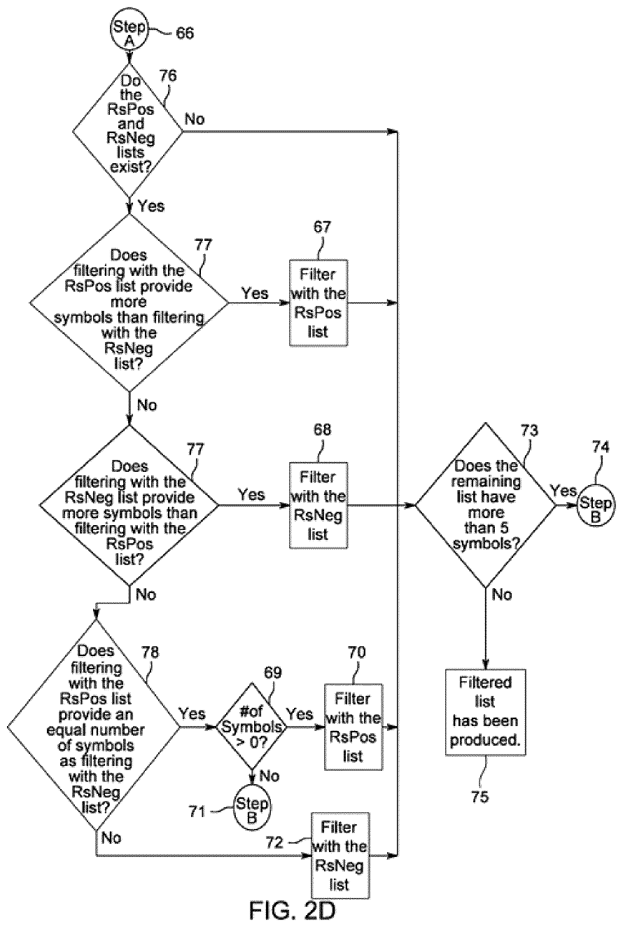

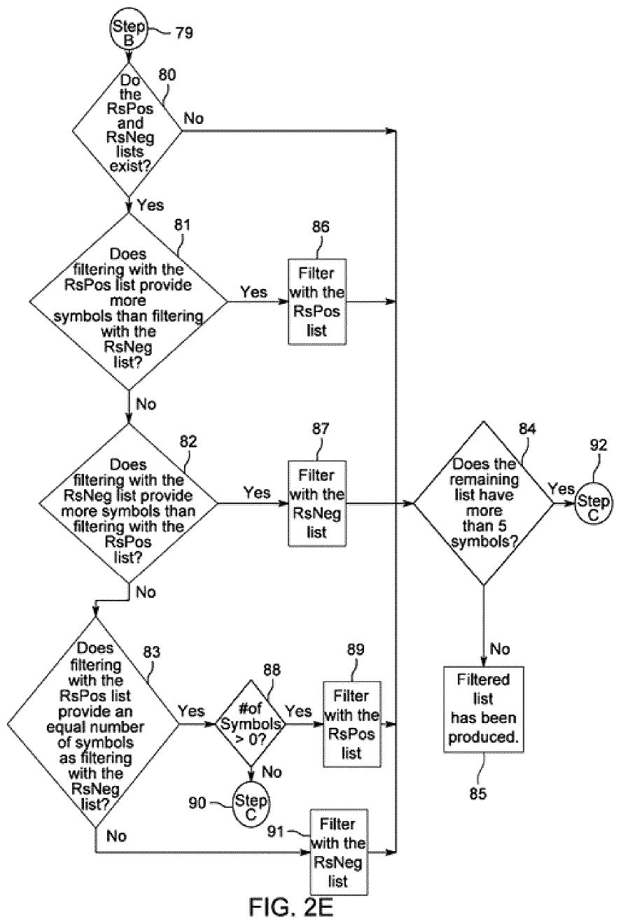

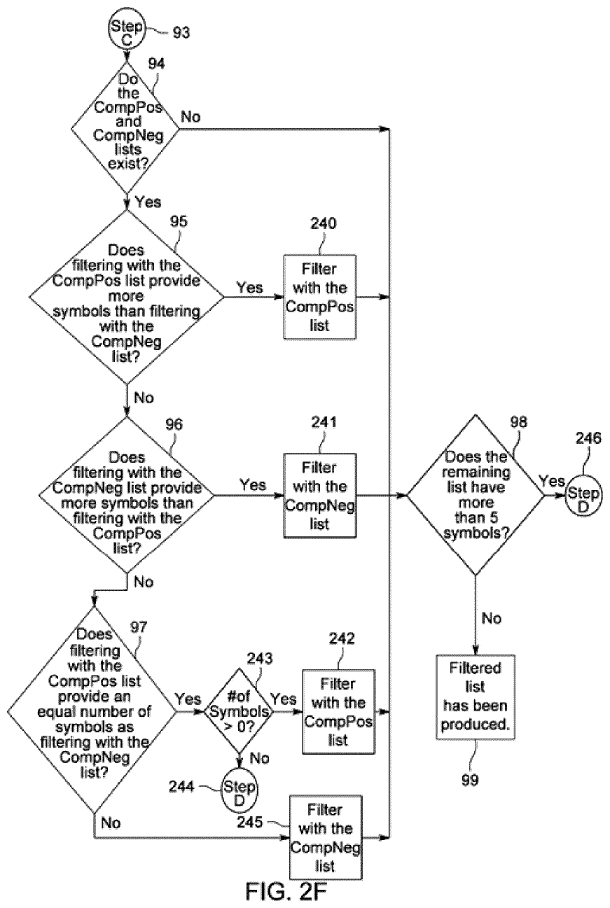

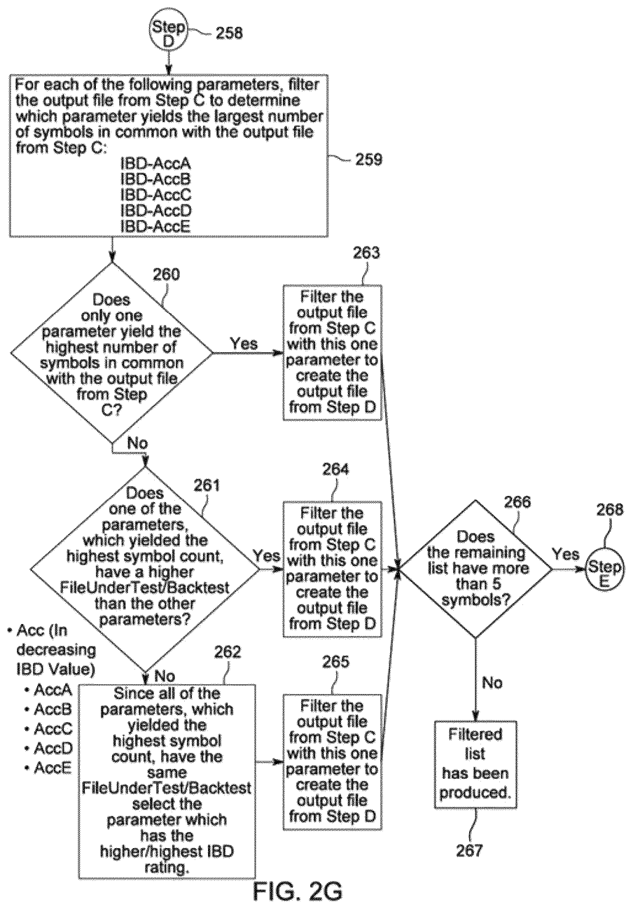

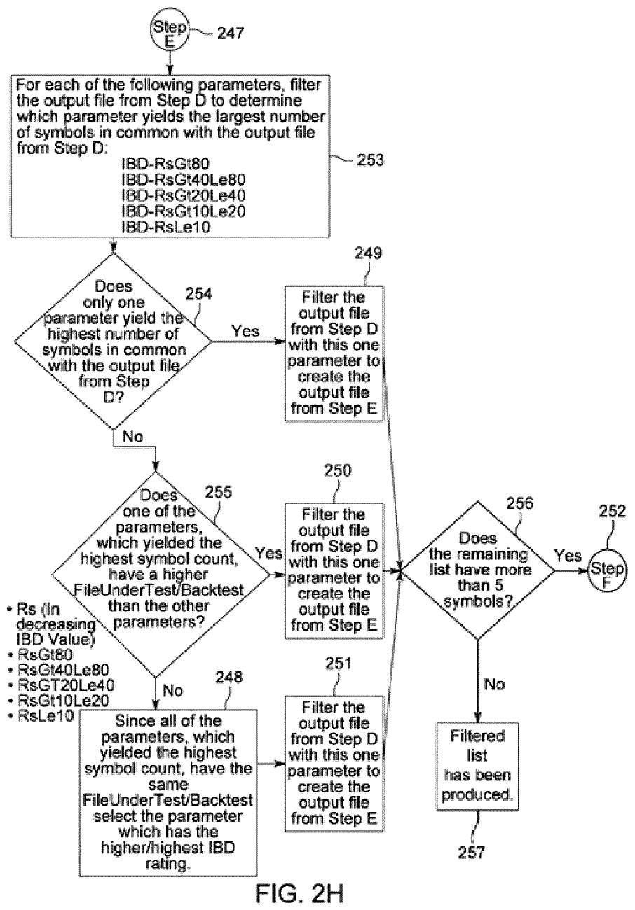

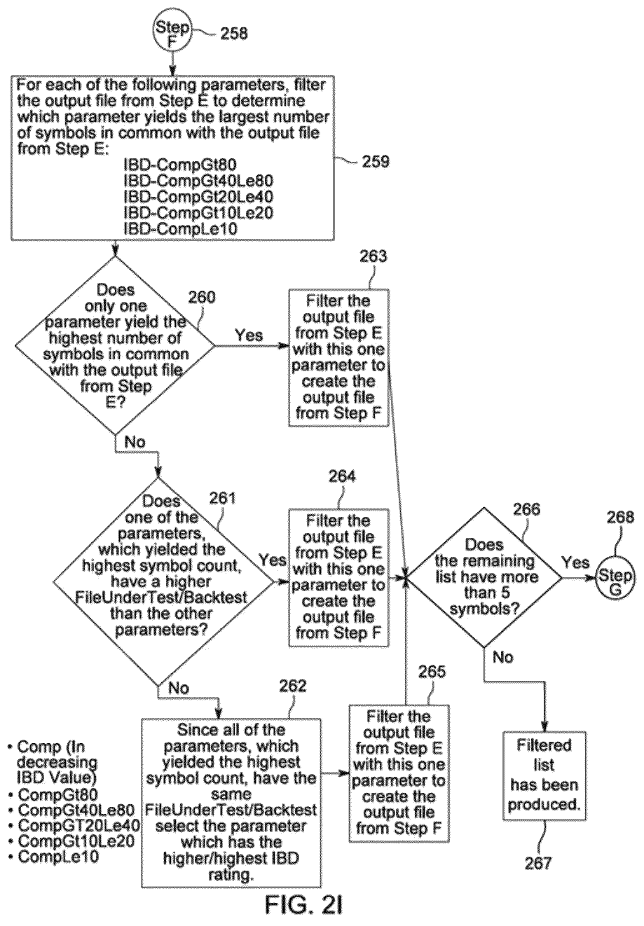

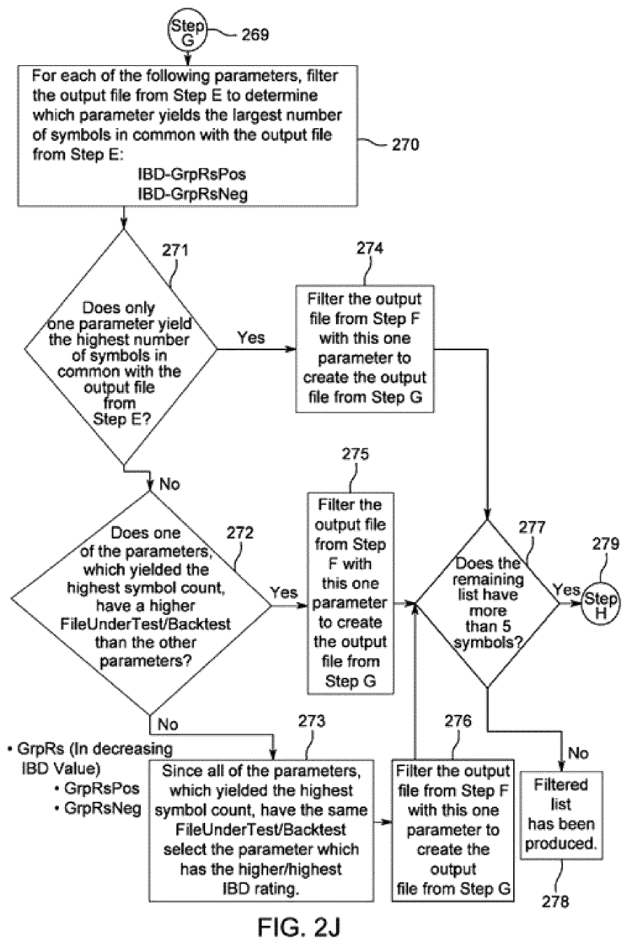

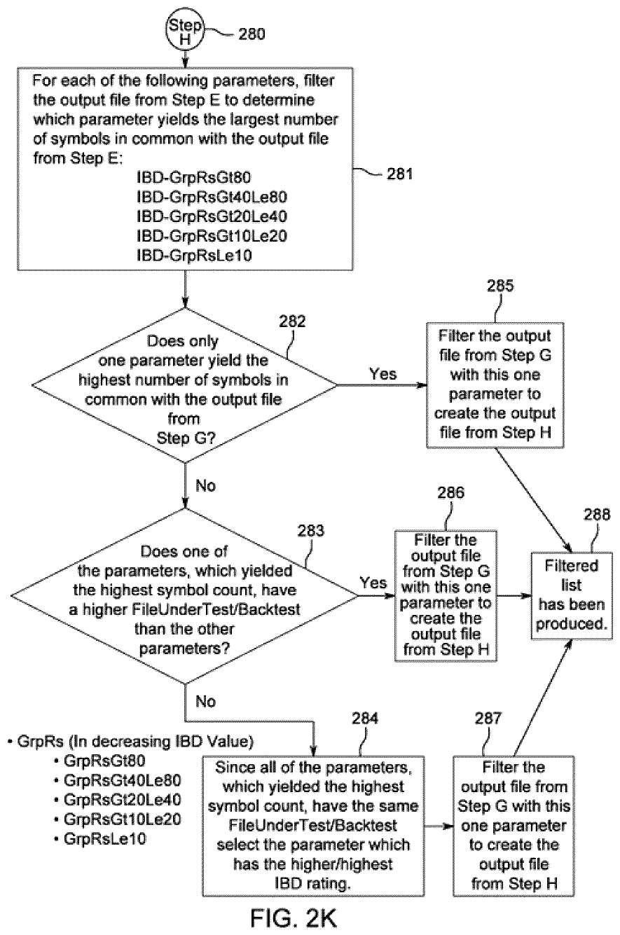

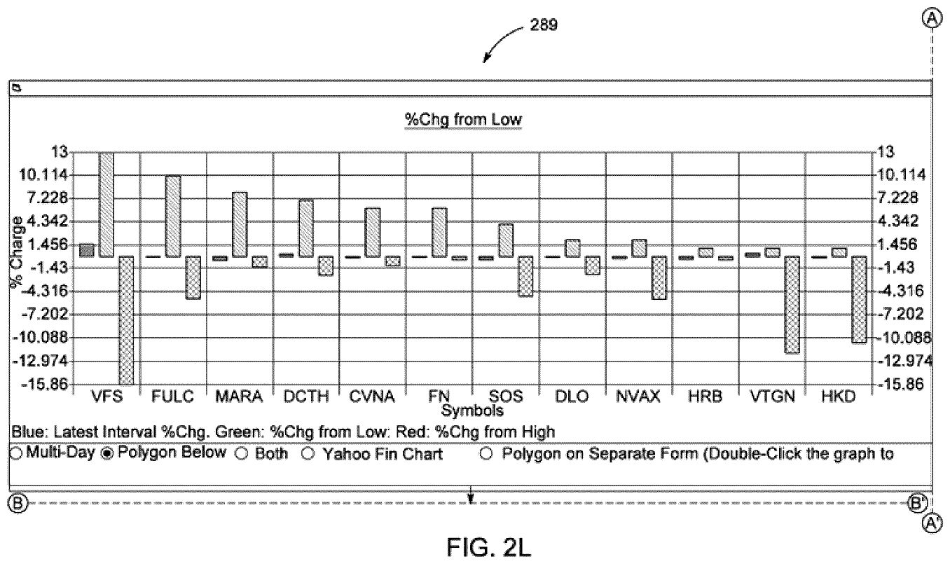

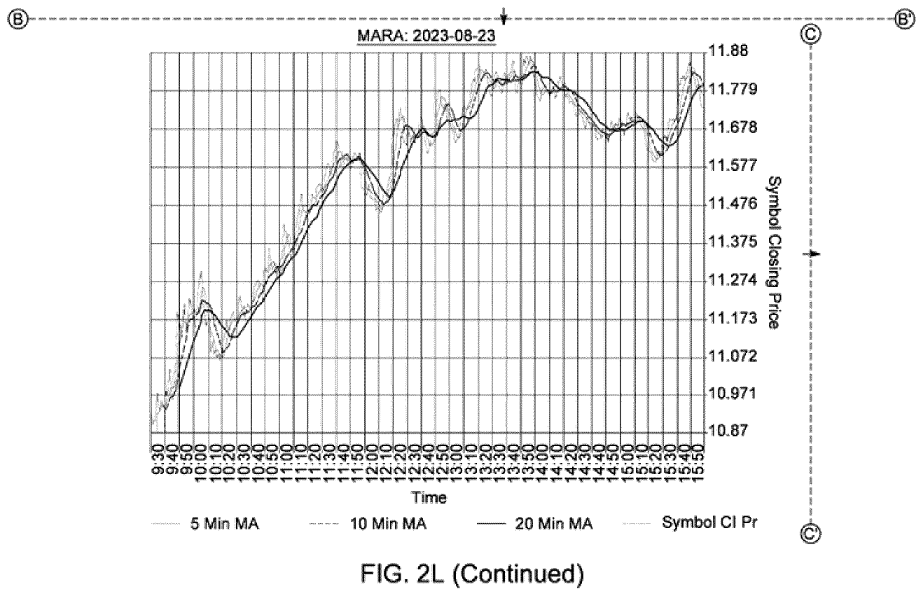

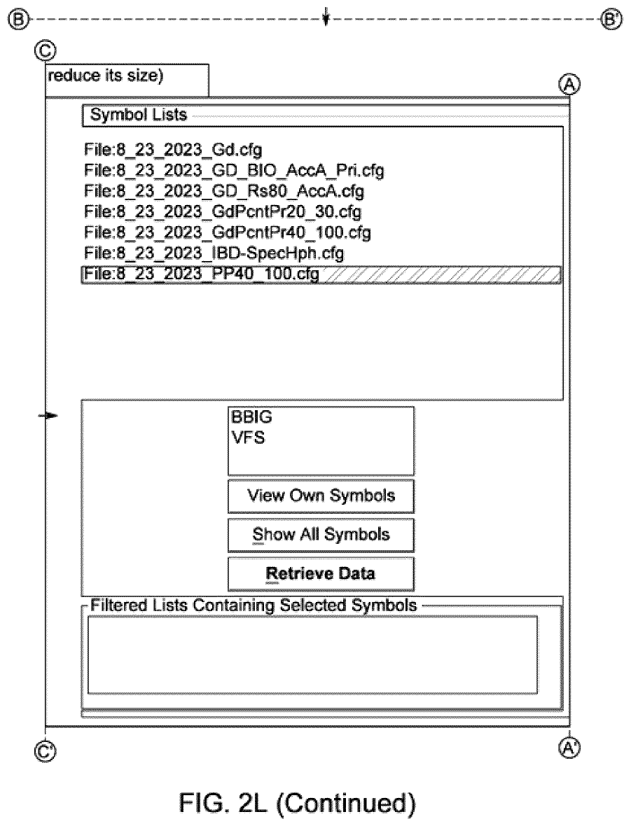

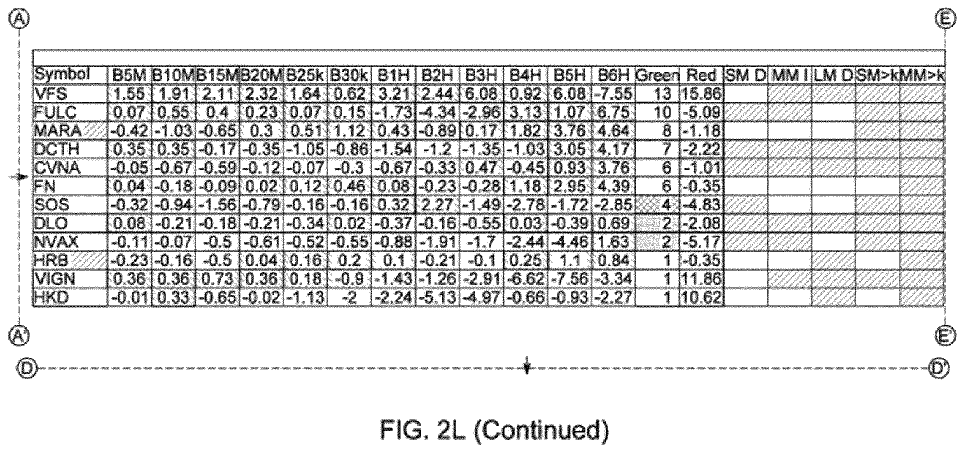

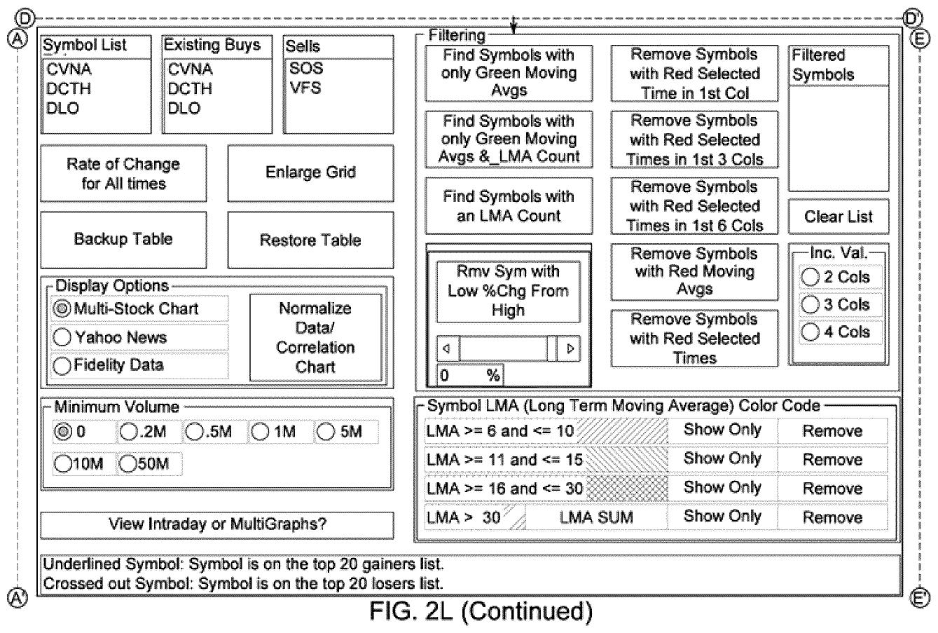

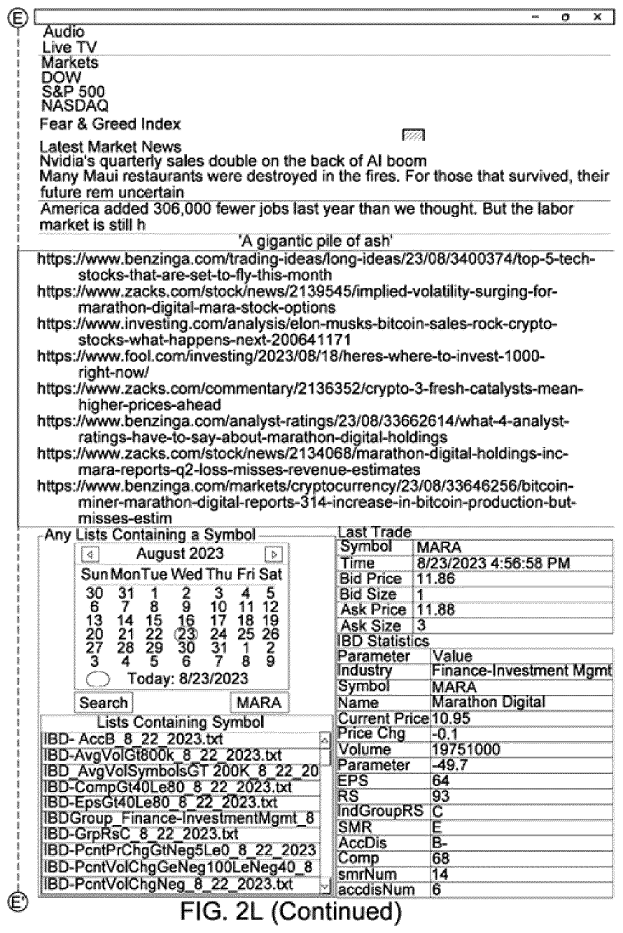

Once the unfiltered set 120 is established and/or created, a filter 130 can be applied, which reduces the set 120, which typically includes over 100 unique stocks to the post-filter set 144. In one embodiment, a fixed or configurable quantity, referred to as the primary quantity, can be set for the post-filter set 144. In a preferred embodiment, the primary quantity is five. Once the post-filter set 144 is created, the stocks 148 contained therein can be simultaneously displayed 146, such as on computing device 220. One non-limiting example of such as display is provided by FIG. 2L.

In one embodiment, additional information, referred to as filter data 112 can be extracted over network 210 from one or more sources to be used by the filter 130. The obtained data 112 can be stored in data store 232 and controlled by server or computing device 224. In one embodiment, end of day stock information is included in the filter data 112. A source for the filter data 112 can be EODDATA.COM, which provides end of day stock market data and historical quotes for many exchanges including NASDAQ, NYSE, AMEX, TSX, and OTCBB. Other sources include those provided by GOOGLE, YAHOO!, and MSN. AMIBROKER comes with a free tool called AMIQOTE able to directly import YAHOO! data. Use of a free tool is may be beneficial to a trader with limited resources, who do not wish to incur monthly investments for stock data. STOCKDATA (e.g., STOCKDATA.ORG) also provides a free real-time, intraday and historical stock data API, which is usable in embodiments. Any source able to provide filter data 112 sufficient for the purposes of filter 130, as described herein, may be utilized, as can be understood by one of ordinary skill in the art.

Stock information 114 conveyed over network 210 to update displayed stock 148 information about the stocks in set 144 can be obtained from one or more sources. The stock information 114 is stored in a data store 234 controlled by server or computing device 236. In embodiments, the stock information 114 is obtained from POLYGON. 10 and/or YAHOO.COM. Other sources of stock information 114 include, but are not limited to: ALPHAVANTAGE.CO, FINNHUB.1O, IXCLOUD.1O, ALPACA.MARKETS and MARKETSTACK.COM.

In general, the filter 130 uses historical information, often limited to a single prior day, to determine five stocks (in the set 144) of interest having a high probability of having an average (close-low) percentage change greater than three (3) percent(%). More specifically, the goal for every trading day is to identify five or fewer unique stocks that are placed in set 144. An average % change (close-low) for the stocks in the set 144 should be ideally 3% or greater, although the best % change can occur hours before a close of the trading day. The filter 130 generally utilizes multiple steps or sub-filters, which include a performance filter(s) 132 and a set of ranking filter(s) 134. Preferably, performance filtering is performed before filtering based on rank. Preferably, each successive step of filtering (via filter 130) results in an increased average ¾ change (close-low) for the remaining stocks. The various steps involving the sub-filters occur in a defined order, where the steps exit once a quantity of stocks remaining is equal to or less than the primary quantity, which is preferably five. FIG. 2B provides stepwise details of this process consistent with FIG. 1A.

With reference to FIG. 1B, performance filter 132 can be performed in stages, where the first is a filter 160 based on Acc, a second is a filter 164 based on Rs, and a third is a filter 168 based on Comp. Results from post-performance filtering 138 can be used as input for ranking filter 134. Filter 160 can utilize one of an AccPos and AccNeg list. Filter 164 can utilize one of an RsPos and RsNeg list. Filter 168 can use one of a CompPos and CompNeg list. The Pos or Neg list that provides a greater number of unique stocks is the one used, when there is a selection between two lists.

With reference to FIG. 1C, ranking filtering can be performed in stages, where the first is a filter 170 based on Acc, a second is a filter 172 based on Rs, a third is a filter 174 based on Comp, a fourth is a filter 176 based on GrpRs Pos and GrpRs Neg, and a fifth is a filter 178 based on GrpRs ranking. Parameters of the several types are selected based on those that yield a greater number of results.

By default, once subset 142 only include the primary quantity, it is considered the set 144 and filtering operations are terminated. Filtering operations may terminate early, however, based upon reaching the primary quantity through an earlier sequenced filtering operation. Although in a preferred embodiment, the filtering operations depicted and the order are significant, other embodiments can alter the order and still be considered within scope of the disclosure.

As shown in FIG. 2A, the first sub-filter threshold can filter out stocks based on the minimum current day volume (e.g., I million), minimum current day close (e.g.,. >5), minimum % change day from current day low(>10%), minimum % change current day close from high(<3%), and the like. Note that FIG. 2A shows a generation of multiple different post-primary-filter sets 144, which result from application of different filters (e.g., Filters A-I to generate sets A-I).

In some embodiments, a method for filtering tradable stocks may include a list of tradable stocks 2 being initially provided, including stock data for the current day and the previous day, such as volume, high price, low price, and close price values. At block 10, a first filtering operation is performed. In some embodiments, stocks are filtered based on a minimum current day trading volume of greater than or equal to 1,000,000 shares, a minimum current day closing price greater than 5, a minimum percentage change from the current day low greater than 10%, and a minimum percentage change from the current day close relative to the current day high of less than 3%. At block 12, a second filtering operation is performed. Stocks are filtered based on a minimum current day trading volume of greater than or equal to 1,000,000 shares, a minimum current day close greater than 5, a minimum percentage change from the current day low greater than 10%, a minimum five-day high percentage greater than 5%, and a minimum five-day low percentage greater than 5%. At block 14, a third filtering operation is performed. In this embodiment, stocks are selected based on a minimum current day trading volume greater than or equal to 1,000,000 shares, a minimum current day close greater than 5, a minimum percentage change from the current day low greater than 0%, a minimum five-day high percentage greater than 10%, and a minimum five-day low percentage greater than 10%.

At block 16, a fourth filtering operation is performed. Stocks are selected based on a minimum current day trading volume greater than or equal to 1,000,000 shares, a minimum current day close greater than 5, and a minimum percentage change from the current day close relative to the low greater than 9%.

After completion of the initial filtering stage, the stocks are processed through a secondary and primary filtering stage. At block 18, a secondary filter is applied based on growth and decline (GD), IBD relative strength (IBD-RS) greater than 80, and IBD accumulation rating A (IBD-Acc A) criteria, generating Symbol List A. At block 20, another secondary filter is applied based on GD, IBD-Acc A, and a primary filter, generating Symbol List B.

At block 22, a filter based on GD, IBD earnings per share rating (IBD-EPS), IBD-Acc A, and a primary filter is applied to generate Symbol List C. At block 24, stocks are filtered based on GD and a portfolio percentage change greater than 30%, generating Symbol List D. At block 26, stocks are filtered based on GD and historical IBD relative strength rankings, specifically where IBD-RS one day ago and IBD-RS five days ago are both greater than 50%, to generate Symbol List E.

At block 28, a filtering operation is performed based on GD and a portfolio percentage change greater than 40%, generating Symbol List F. At block 30, stocks are filtered based on GD and a portfolio percentage change greater than 30%, generating Symbol List G. At block 32, a similar filtering process is applied based on GD and a portfolio percentage change greater than 30%, generating Symbol List H. At block 34, stocks are filtered based on GD and a primary filter to generate Symbol List I.

Definitions for the filtering criteria are provided in FIG. 2A and include the following: (1) “%D Open” is calculated as ((Current Day Open-Previous Day Open)/Previous Day Open)×100; (2) “%D High” is calculated as ((Current Day High-Previous Day High)/Previous Day High) ×100; (3) “%D Low” is calculated as ((Current Day Low-Previous Day Low)/Previous Day Low)×100; (4) “%D Close” is calculated as ((Current Day Close-Previous Day Close)/Previous Day Close)×100; and (5) “Port % Change” is calculated as (Price Change/Price)×100.

The goal of the method, as indicated in FIG. 2A, is to generate symbol lists each day containing five (5) or fewer stocks, with the average percentage change from the close to the low price for the included stocks being at least three percent (3%) or greater.

In some embodiments, backtesting is conducted using a backtest average file, which is derived from, for example, a ten-day moving average of individual daily backtest performance files. Each of these daily performance files is generated after the close of the trading day and captures metrics for a wide array of symbol lists. In some embodiments, the daily backtest file includes the percentage of symbols within each list that experienced a price increase, a price decrease, or remained unchanged. The resulting ten-day moving average of these daily metrics is compiled into the backtest average file, which plays a key role in the primary filtering process used in trading analysis.

The lists evaluated span various categories and performance segments, including but not limited to: a wide range of classifications such as IBD-AccA, IBD-AccB, IBD-AccC, IBD-AccD, IBD-AccDis-NegPerformance, IBD-AccDis-PosPerformance, IBD-AccE, IBD-Avg VolGt100kLt200k, IBD-AvgVolGt200kLt400k, IBD-AvgVolGt400kLt800k, IBD-Avg VolGt800k, IBD-AvgVolLt100k, IBD-AvgVolSymbolsGT200K, IBD-CompGt10Le20, IBD-CompGt20Le40, IBD-CompGt40Le80, IBD-CompGt80, IBD-CompLe10, IBD-Comp-NegPerformance, IBD-Comp-PosPerformance, IBD-EpsGt10Le20, IBD-EpsGt20Le40, IBD-EpsGt40Le80, IBD-EpsGt80, IBD-EpsLe10, IBD-EPS-NegPosPerformance, IBD-EPS-PosPerformance, IBD-GD, IBD-GrpRsA, IBD-GrpRsB, IBD-GrpRsC, IBD-GrpRsD, IBD-GrpRsE, IBD-grpRS-NegPerformance, IBD-grpRS-PosPerformance, IBD-PcntPrChgGt0LePos5, IBD-PcntPrChgGtNeg100LeNeg40, IBD-PcntPrChgGtNeg10LeNeg5, IBD-PcntPrChgGtNeg20LeNeg10, IBD-PcntPrChgGtNeg30LeNeg20, IBD-PcntPrChgGtNeg40LeNeg30, IBD-PcntPrChgGtNeg5Le0, IBD-PcntPrChgGtPos10LePos20, IBD-PcntPrChgGtPos20LePos30, IBD-PcntPrChgGtPos30LePos40, IBD-PcntPrChgGtPos40LePos100, IBD-PcntPrChgGtPos5LePos10, IBD-PcntVolChgGe0LePos5, IBD-PontVolChgGeNeg100LeNeg40, IBD-PcntVolChgGt100LePos200, IBD-PcntVolChgGt10LePos20, IBD-PcntVolChgGt1600LePos3200, IBD-PcntVolChgGt200LePos400, IBD-PcntVolChgGt20LePos30, IBD-PcntVolChgGt30LePos40, IBD-PcntVolChgGt3200, IBD-PontVolChgGt400LePos800, IBD-PcntVolChgGt40LePos100, IBD-PcntVolChgGt5LePos10, IBD-Pont VolChgGt800LePos1600, IBD-PcntVolChgGtNeg10LeNeg5, IBD-Pont VolChgGtNeg20LeNeg10, IBD-PcntVolChgGtNeg30LeNeg20, IBD-PentVolChgGtNeg40LeNeg30, IBD-PcntVolChgGtNeg5LT0, IBD-PcntVolChgLTNeg100, IBD-Pcnt VolChgNeg, IBD-PcntVolChgPos, IBD-PcntVolChgUnch, IBD-PrChgNeg, IBD-PrChgPos, IBD-PrChgUnch, IBD-PrGt10Le20, IBD-PrGt20Le40, IBD-PrGt40Le80, IBD-PrGt5Le10, IBD-PrGt80, IBD-PrLt5, IBD-RsGt10Le20, IBD-RsGt20Le40, IBD-RsGt40Le80, IBD-RsGt80, IBD-RsLe10, IBD-RS-NegPerformance, IBD-RS-PosPerformance, IBD-SmrA, IBD-SmrB, IBD-SmrC, IBD-SmrD, IBD-SmrE, IBD-SMR-NegPerformance, IBD-SMR-PosPerformance, IBD-SpecHph, IBDGroup_Aerospace-Defense, IBDGroup_AgriculturalOperations, IBDGroup_Apparel-ClothingMfg, IBDGroup_Apparel-Shoes&Rel Mfg, IBDGroup_AutoManufacturers, IBDGroup_Auto-Truck-OriginalEqp, IBDGroup_Auto-Truck-ReplaceParts, IBDGroup_Auto-Truck-Tires&Misc, IBDGroup_Banks-Foreign, IBDGroup_Banks-Midwest, IBDGroup_Banks-MoneyCenter, IBDGroup_Banks-Northeast, IBDGroup_Banks-Southeast, IBDGroup_Banks-SuperRegional, IBDGroup_Banks-West-Southwest, IBDGroup_Beverages-Alcoholic, IBDGroup_Beverages-Non-Alcoholic, IBDGroup_Bldg-A-C&Heating Prds, IBDGroup_Bldg-Cement-Concrt-Ag, IBDGroup_Bldg-ConstrPrds-Misc, IBDGroup_Bldg-HandTools, IBDGroup_Bldg-HeavyConstruction, IBDGroup_Bldg-Maintenance&Svc, IBDGroup_Bldg-Mobile-Mfg&Rv, IBDGroup_Bldg-Resident-Comml, IBDGroup_Bldg-WoodPrds, IBDGroup_Chemicals-Agricultural, IBDGroup_Chemicals-Basic, IBDGroup_Chemicals-Paints, IBDGroup_Chemicals-Plastics, IBDGroup_Chemicals-Specialty, IBDGroup_CommlSvcs-Advertising, IBDGroup_CommlSvcs-Consulting, IBDGroup_CommlSvcs-DocumentMgmt, IBDGroup_CommlSvcs-Healthcare, IBDGroup_CommlSvcs-Leasing, IBDGroup_CommlSvcs-MarketRsrch, IBDGroup_CommlSvcs-Outsourcing, IBDGroup_CommlSvcs-Staffing, IBDGroup_CompSftwr-SpecEnterprs, IBDGroup_Computer-DataStorage, IBDGroup_Computer-Hardware-Perip, IBDGroup_Computer-IntegratedSyst, IBDGroup_Computer-Networking, IBDGroup_ComputerSftwr-Database, IBDGroup_ComputerSftwr-Design, IBDGroup_ComputerSftwr-Desktop, IBDGroup_ComputerSftwr-Edu-Media, IBDGroup_ComputerSftwr-Enterprse, IBDGroup_ComputerSftwr-Financial, IBDGroup_ComputerSftwr-Gaming, IBDGroup_ComputerSftwr-Medical, IBDGroup_ComputerSftwr-Security, IBDGroup_Computer-TechServices, IBDGroup_ConsumerProd-Electronic, IBDGroup_ConsumerProd-Specialty, IBDGroup_ConsumerSvcs-Education, IBDGroup_Containers-Packaging, IBDGroup_Cosmetics-PersonalCare, IBDGroup_DiversifiedOperations, IBDGroup_Elec-ContractMfg, IBDGroup_Elec-MiscProducts, IBDGroup_Elec-Scientific-Msrng, IBDGroup_Elec-SemicondctorFablss, IBDGroup_Elec-SemiconductorEquip, IBDGroup_Elec-SemiconductorMfg, IBDGroup_Electrical-Power-Equipmt, IBDGroup_Electronic-Parts, IBDGroup_Energy-Alternative-Other, IBDGroup_Energy-Coal, IBDGroup_Energy-Solar, IBDGroup_Finance-BlankCheck, IBDGroup_Finance-CommercialLoans, IBDGroup_Finance-ConsumerLoans, IBDGroup_Finance-CrdtCard-PmtPr, IBDGroup_Finance-ETF-ETN, IBDGroup_Finance-InvestBnk-Bkrs, IBDGroup_Finance-InvestmentMgmt, IBDGroup_Finance-MortgageREIT, IBDGroup_Finance-Mrtg&RelSvc, IBDGroup_Finance-PropertyREIT, IBDGroup_Finance-PublInvFd-Bal, IBDGroup_Finance-PublInvFd-Bond, IBDGroup_Finance-PublInvFd-Eqt, IBDGroup_Finance-PublInvFd-Glbl, IBDGroup_Finance-Savings&Loan, IBDGroup_FinancialSvcs-Specialty, IBDGroup_Food-Confectionery, IBDGroup_Food-DairyProducts, IBDGroup_Food-Grain&Related, IBDGroup_Food-MeatProducts, IBDGroup_Food-MiscPreparation, IBDGroup_Food-Packaged, IBDGroup_FuneralSvcs& Rel, IBDGroup_Groupnotavailable, IBDGroup_Hsehold-Appliances-Wares, IBDGroup_Hsehold-OfficeFurniture, IBDGroup_Insurance-Acc&Health, IBDGroup_Insurance-Brokers, IBDGroup_Insurance-Diversified, IBDGroup_Insurance-Life, IBDGroup_Insurance-Prop-Cas-Titl, IBDGroup_Internet-Content, IBDGroup_Internet-NetworkSltns, IBDGroup_Leisure-Gaming-Equip, IBDGroup_Leisure-Lodging, IBDGroup_Leisure-Movies&Related, IBDGroup_Leisure-Products, IBDGroup_Leisure-Services, IBDGroup_Leisure-Toys-Games-Hobby, IBDGroup_Leisure-TravelBooking, IBDGroup_Machinery-Constr-Mining, IBDGroup_Machinery-Farm, IBDGroup_Machinery-GenIndustrial, IBDGroup_Machinery-MtlHdlg-Autmn, IBDGroup_Machinery-Tools&Rel, IBDGroup_Media-Books, IBDGroup_Media-Diversified, IBDGroup_Media-Newspapers, IBDGroup_Media-Radio-Tv, IBDGroup_Medical-Biomed-Biotech, IBDGroup_Medical-Diversified, IBDGroup_Medical-EthicalDrugs, IBDGroup_Medical-GenericDrugs, IBDGroup_Medical-Hospitals, IBDGroup_Medical-Long-termCare, IBDGroup_Medical-ManagedCare, IBDGroup_Medical-Outpnt-HmCare, IBDGroup_Medical-Products, IBDGroup_Medical-ResearchEqp-Svc, IBDGroup_Medical-Services, IBDGroup_Medical-Supplies, IBDGroup_Medical-Systems-Equip, IBDGroup_Medical-WhlsleDrg-Suppl, IBDGroup_MetalPrds-Distributor, IBDGroup_MetalProc& Fabrication, IBDGroup_Mining-Gold-Silver-Gems, IBDGroup_Mining-MetalOres, IBDGroup_OfficeSuppliesMfg, IBDGroup_Oil& Gas-CdnExpl&Prod, IBDGroup_Oil&Gas-Drilling, IBDGroup_Oil&Gas-FieldServices, IBDGroup_Oil&Gas-Integrated, IBDGroup_Oil&Gas-IntlExpl&Prod, IBDGroup_Oil&Gas-Machinery-Equip, IBDGroup_Oil&Gas-Refining-Mktg, IBDGroup_Oil&Gas-RoyaltyTrust, IBDGroup_Oil&Gas-Transprt-Pipelne, IBDGroup_Oil& Gas-USExpl&Prod, IBDGroup_Paper&Paper Products, IBDGroup_PollutionControl, IBDGroup_RealEstateDvlpmt-Ops, IBDGroup_Retail-Apparel-Shoes-Acc, IBDGroup_Retail-ConsumerElec, IBDGroup_Retail-DepartmentStores, IBDGroup_Retail-Discount& Variety, IBDGroup_Retail-DrugStores, IBDGroup_Retail-HomeFurnishings, IBDGroup_Retail-Internet, IBDGroup_Retail-LeisureProducts, IBDGroup_Retail-MailOrder&Direct, IBDGroup_Retail-MajorDiscChains, IBDGroup_Retail-Restaurants, IBDGroup_Retail-Specialty, IBDGroup_Retail-Super-MiniMkts, IBDGroup_Retail-Whlsle-Automobile, IBDGroup_Retail-Whlsle-AutoParts, IBDGroup_Retail-Whlsle-BldgPrds, IBDGroup_Retail-Whlsle-Jewelry, IBDGroup_Retail-Whlsle-OfficeSup, IBDGroup_Security-Sfty, IBDGroup_Soap&Clng Preparatns, IBDGroup_Steel-Producers, IBDGroup_Steel-Specialty Alloys, IBDGroup_Telecom-Cable-SatlEqp, IBDGroup_Telecom-ConsumerProds, IBDGroup_Telecom-FiberOptics, IBDGroup_Telecom-Infrastructure, IBDGroup_TelecomSvcs-Cable-Satl, IBDGroup_TelecomSvcs-Foreign, IBDGroup_TelecomSvcs-Integrated, IBDGroup_TelecomSvcs-Wireless, IBDGroup_Tobacco, IBDGroup_Transport-AirFreight, IBDGroup_Transportation-Airline, IBDGroup_Transportation-EquipMfg, IBDGroup_Transportation-Logistics, IBDGroup_Transportation-Rail, IBDGroup_Transportation-Ship, IBDGroup_Transportation-Truck, IBDGroup_Trucks&Parts-Hvy Duty, IBDGroup_Utility-Diversified, IBDGroup_Utility-ElectricPower, IBDGroup_Utility-GasDistribution, IBDGroup_Utility-WaterSupply, IBDGroup_Wholesale-Electronics, IBDGroup_Wholesale-Food.

Each of these categories contributes to the daily snapshot and the smoothed ten-day backtest average, which collectively inform the selection and filtering of symbols in the overall trading system.

With reference to FIG. 2B, in indicated Step 1, the unfiltered set 120 is selected. With reference to Step 2 of FIG. 2B, the filter 132 is applied to filter out stocks having less than 800,000 shares by 50 day moving average. With reference to Step 3, performance filter 132 is applied. With reference to Step 3A, the Acc performance filter 160 is applied. AccPos or AccNeg is selected based on which yields the most symbols. If AccPos and AccNeg files yield the same number of symbols then select the AccPos or AccNeg file with the higher FileUnderTest/Backtest. If both AccPos and AccNeg files have the same FileUnderTest/Backtest, then AccPos is used. With reference to Step 3B, the Rs performance filter 164 is applied. RsPos or RsNeg is selected based on which yields the most symbols. IfRsPos and RsNeg files yield the same number of symbols then the RsPos or RsNeg file with the higher FileUnderTest/Backtest is selected. If both RsPos and RsNeg files have the same FileUnderTest/Backtest, then RsPos is used. With reference to Step 3C, the Comp performance filter 168 is applied. CompPos or CompNeg is selected based on which yields the most symbols. If CompPos and CompNeg files yield the same number of symbols then the CompPos or CompNeg file with the higher FileUnderTest/Backtest is selected. If both CompPos and CompNeg files have the same FileUnderTest/Backtest, then CompPos is used.

The lists of prior trading symbols are categorized based on whether specific metrics increased or decreased compared to the day preceding the prior trading day. AccPos includes symbols for which the Acc value increased, while RsPos, CompPos, GrpRsPos, and SmrPos include symbols showing increases in the Rs, Comp, GrpRs, and Smr values, respectively. Conversely, AccNeg captures symbols where the Acc value decreased, and similarly, RsNeg, CompNeg, GrpRsNeg, and SmrNeg list symbols where the Rs, Comp, GrpRs, and Smr values declined from the trading day just before the prior trading day.

In particular, AccPos is the list of the prior trading symbols where the Acc value increased from the trading day just before the prior trading day. RsPos is the list of the prior trading symbols where the Rs value increased from the trading day just before the prior trading day. CompPos is the list of the prior trading symbols where the Comp value increased from the trading day just before the prior trading day. GrpRsPos is the list of the prior trading symbols where the GrpRs value increased from the trading day just before the prior trading day. SmrPos is the list of the prior trading symbols where the Smr value increased from the trading day just before the prior trading day. AccNeg is the list of the prior trading symbols where the Acc value decreased from the trading day just before the prior trading day. RsNeg is the list of the prior trading symbols where the Rs value decreased from the trading day just before the prior trading day. CompNeg is the list of the prior trading symbols where the Comp value decreased from the trading day just before the prior trading day. GrpRsNeg is the list of the prior trading symbols where the GrpRs value decreased from the trading day just before the prior trading day. SmrNeg is the list of the prior trading symbols where the Smr value decreased from the trading day just before the prior trading day.

As indicated by Step 4, filter 134 is applied. With reference to Step 4A, filter 170 is applied. Acc parameter is selected based on which yields the most symbols. When two or more Acc parameters yield the same highest number of symbols, then the Acc parameter with the higher FileUnderTest/Backtest is selected. If these Acc parameters have the same FileUnderTest/Backtest, then the parameter with the higher IBD rating is selected.

With reference to Step 4B, filter 172 is applied. Rs parameter is selected based on which yields the most symbols. When two or more Rs parameters yield the same highest number of symbols, then the Rs parameter with the higher FileUnderTest/Backtest is selected. If Rs parameters have the same FileUnderTest/Backtest, then the parameter with the higher IBD rating is selected.

With reference to Step 4C, filter 174 is applied. Comp parameter is selected based on which yields the most symbols. When two or more Comp parameters yield the same highest number of symbols, then the Comp parameter is selected with the higher FileUnderTest/Backtest. If the Comp parameters have the same FileUnderTest/Backtest, then the parameter with the higher IBD rating is selected.

With reference to Step 4D, filter 176 is applied. GrpRsPos or GrpRsNeg is selected based on which yields the most symbols. When GrpRsPos and GrpRsNeg yield the same number of symbols, then GrpRsPos or GrpRsNeg with the higher FileUnderTest/Backtest is selected. If GrpRsPos and GrpRsNeg have the same FileUnderTest/Backtest, then GrpRsPos is selected.

With reference to Step 4E, filter 178 is applied. GrpRs parameter is selected based on which yields the most symbols. When two or more GrpRs parameters yield the same highest number of symbols, then the GrpRs parameter with the higher FileUnderTest/Backtest is selected. If these GrpRs parameters have the same FileUnderTest/Backtest, then the parameter with the higher IBD rating is selected.

FIG. 2C through 2K depict detailed flow charts depicting an embodiment of the process detailed in pictorial form explained in context of FIG. 1A-C. As shown in FIG. 2C, a method for refining a list of tradable stock symbols is illustrated, according to some embodiments of the present disclosure. At block 36, the method begins by selecting a list of symbols. At block 38, the method includes removing symbols that have a 50-day moving average trading volume of less than 800,000 shares per day. At block 40, the method determines whether the remaining list contains more than five (5) symbols. If the remaining list has five or fewer symbols, the method proceeds to block 42, where the filtered list is finalized and produced. If the remaining list still contains more than five (5) symbols, the method proceeds to block 44, where it is determined whether both the AccPos list and the AccNeg list exist. If neither list exists, the method continues along the right path directly to block 63, discussed below. If both the AccPos and AccNeg lists exist, the method proceeds to block 46, where it is determined whether filtering with the AccPos list produces more symbols than filtering with the AccNeg list. If so, at block 52, filtering is performed using the AccPos list.

If filtering with the AccPos list does not provide more symbols, the method proceeds to block 48, where it is determined whether filtering with the AccNeg list provides more symbols than filtering with the AccPos list. If so, at block 54, filtering is performed using the AccNeg list. If neither the AccPos list nor the AccNeg list provides more symbols, the method advances to block 50, where it is determined whether filtering with the AccPos list provides an equal number of symbols as filtering with the AccNeg list. If not, the method proceeds to block 60, where filtering is performed using the AccNeg list. If the number of symbols is equal, the method proceeds to block 56, where the filtered list is evaluated for size.

At block 56, it is determined whether the number of symbols after filtering is greater than five. If the number is greater than five, filtering is performed with the AccPos list at block 62. If the number is five or fewer, the method proceeds to block 58 to Step A. Step A represents a repeated loop back into the method to perform additional filtering actions. At block 63, if at any point a filtered list is produced and it is determined that the remaining list still contains more than five (5) symbols, the method returns to Step A for further filtering. If the list contains five (5) or fewer symbols, the method proceeds to block 65, where the final filtered list is produced. Thus, FIG. 2C illustrates an iterative decision-making process for refining a list of tradable symbols based on volume thresholds, existence of supplemental filter lists (AccPos and AccNeg), and comparative filtering strategies to achieve a filtered stock list containing no more than five (5) symbols optimized for further monitoring and trading strategies.

As shown in FIG. 2D, a method for further filtering a list of stock symbols is illustrated, according to some embodiments of the present disclosure. The method begins at block 66, where Step A is entered from the preceding filtering process (e.g., as shown in FIG. 2C). At block 76, it is determined whether both the RsPos list and the RsNeg list exist. If neither list exists, the method proceeds directly to block 73, discussed further below. If both lists exist, the method proceeds to block 77, where it is determined whether filtering with the RsPos list provides more symbols than filtering with the RsNeg list. If so, the method continues to block 67, where filtering is performed using the RsPos list.

If filtering with the RsPos list does not provide more symbols, the method proceeds to block 77, where it is determined whether filtering with the RsNeg list provides more symbols than filtering with the RsPos list. If so, the method continues to block 68, where filtering is performed using the RsNeg list. If neither the RsPos list nor the RsNeg list results in a greater number of symbols, the method advances to block 78, where it is determined whether filtering with the RsPos list produces an equal number of symbols compared to filtering with the RsNeg list. If the number of symbols is equal, the method proceeds to block 69, where the resulting number of symbols is evaluated. At block 69, it is determined whether the number of filtered symbols is greater than five. If the number of symbols is greater than five, filtering is performed with the RsPos list at block 70. If the number is five or fewer, the method proceeds to block 71, where Step B is entered for further processing.

If, at block 78, filtering with the RsPos list does not produce an equal number of symbols compared to filtering with the RsNeg list, filtering is performed with the RsNeg list at block 72. Following any of the filtering operations, the method proceeds to block 73, where it is determined whether the resulting list contains more than five (5) symbols. If the list contains more than five symbols, the method moves to Step B at block 74 to perform additional filtering iterations. If the list contains five or fewer symbols, the method proceeds to block 75, where the final filtered list is produced. Thus, FIG. 2D illustrates an iterative and comparative decision-making process that further refines stock symbol lists based on the existence and performance of RsPos and RsNeg supplemental lists, with the goal of producing a final stock list of five or fewer symbols suitable for trading actions.

As shown in FIG. 2E, a method for further refining a filtered list of stock symbols is illustrated, according to some embodiments of the present disclosure. The method begins at block 79, where Step B is entered from the preceding filtering process (e.g., from FIG. 2D). At block 80, the method determines whether both the RsPos list and the RsNeg list exist. If neither list exists, the method proceeds directly to block 84, discussed below. If both lists exist, the method proceeds to block 81, where it is determined whether filtering with the RsPos list produces more symbols than filtering with the RsNeg list. If so, the method proceeds to block 86, where filtering is performed using the RsPos list. If filtering with the RsPos list does not provide more symbols, the method proceeds to block 82, where it is determined whether filtering with the RsNeg list produces more symbols than filtering with the RsPos list. If so, the method proceeds to block 87, where filtering is performed using the RsNeg list. If neither the RsPos list nor the RsNeg list produces more symbols, the method advances to block 83, where it is determined whether filtering with the RsPos list provides an equal number of symbols compared to filtering with the RsNeg list. If not, the method proceeds to block 91, where filtering is performed using the RsNeg list.

If the number of symbols produced by filtering with the RsPos list and RsNeg list is equal, the method proceeds to block 88, where it is determined whether the number of filtered symbols exceeds zero (0). If the number is greater than zero, filtering is performed with the RsPos list at block 89. If the number is 0 or fewer, the method proceeds to block 90, where Step C is entered for additional processing. After any of the filtering operations, the method proceeds to block 84, where it is determined whether the resulting list contains more than five (5) symbols. If the list contains more than five symbols, the method moves to Step C, at block 92. If the list contains five or fewer symbols, the method proceeds to block 85, where the final filtered list is produced. Thus, FIG. 2E illustrates a continued iterative and comparative filtering decision process, using the RsPos and RsNeg lists to ensure that the final stock symbol list is refined to no more than five (5) symbols optimized for targeted trading.

As shown in FIG. 2F, a method for additional filtering of stock symbols is illustrated, according to some embodiments of the present disclosure. The method begins at block 93, where Step C is entered from the preceding filtering process (e.g., from FIG. 2E). At block 94, it is determined whether both the CompPos list and the CompNeg list exist. If neither list exists, the method proceeds directly to block 98, discussed further below. If both lists exist, the method proceeds to block 95, where it is determined whether filtering with the CompPos list results in more symbols than filtering with the CompNeg list. If so, the method proceeds to block 240, where filtering is performed using the CompPos list. If filtering with the CompPos list does not produce more symbols, the method advances to block 96, where it is determined whether filtering with the CompNeg list provides more symbols than filtering with the CompPos list. If so, the method proceeds to block 241, where filtering is performed using the CompNeg list. If neither the CompPos list nor the CompNeg list provides more symbols, the method advances to block 97, where it is determined whether filtering with the CompPos list and the CompNeg list results in an equal number of symbols. If not, filtering is performed with the CompNeg list at block 245.

If the number of symbols produced by both the CompPos and CompNeg lists is equal, the method proceeds to block 243, where the number of filtered symbols is evaluated. At block 243, it is determined whether the number of filtered symbols exceeds five (5). If the number is greater than five, filtering is performed with the CompPos list at block 242. If the number is five or fewer, the method proceeds to block 244, where Step D is entered for additional filtering. After any of the filtering operations, the method proceeds to block 98, where it is determined whether the resulting filtered list still has more than five (5) symbols. If the list contains more than five symbols, the method loops to Step D at block 246. If the list contains five or fewer symbols, the method proceeds to block 99, where the final filtered list is produced. Thus, FIG. 2F illustrates a continuation of the iterative, comparative filtering process using the CompPos and CompNeg supplemental lists to ensure that the final list of stock symbols is reduced to no more than five (5) symbols for targeted trading analysis.

As shown in FIG. 2G, a method for further refining a filtered list of stock symbols using backtesting and ratings criteria is illustrated, according to some embodiments of the present disclosure. The method begins at block 258, where Step D is entered from the preceding filtering process (e.g., from FIG. 2F). At block 259, the method includes filtering the output file from Step C based on a set of parameters to determine which parameter yields the largest number of symbols in common with the output file from Step C. The parameters may include: IBD-AccA, IBD-AccB, IBD-AccC, IBD-AccD, and IBD-AccE. At block 260, it is determined whether only one of the parameters yields the highest number of symbols in common with the output file from Step C. If so, the method proceeds to block 263, where the output file from Step C is filtered using this one parameter to create the output file for Step D. If more than one parameter yields the highest symbol count, the method proceeds to block 261, where it is determined whether any one of the parameters that produced the highest symbol count has a higher FileUnderTest backtest score than the others. If one parameter does have a higher backtest score, the method proceeds to block 264, where the output file from Step C is filtered with that parameter to create the output file for Step D.

If no parameter has a higher backtest score than the others, the method proceeds to block 262, where the parameter with the highest IBD rating (in decreasing order AccA, AccB, AccC, AccD, AccE) is selected to perform the filtering. At block 263, block 264 and block 265, filtering is performed using the selected parameter to create the output file for Step D. After filtering, the method proceeds to block 266, where it is determined whether the resulting list has more than five (5) symbols. If the list still has more than five symbols, the method proceeds to Step E, at block 268 for further processing. If the list contains five or fewer symbols, the method proceeds to block 267, where the final filtered list is produced. Thus, FIG. 2G illustrates a multi-criteria decision-making process that uses symbol overlap, backtesting performance, and IBD rating to select the optimal filtering parameter, thereby ensuring production of a highly refined list of stock symbols for further trading analysis.

As shown in FIG. 2H, a method for further refining a filtered list of stock symbols using ranking parameters is illustrated, according to some embodiments of the present disclosure. The method begins at block 247, where Step E is entered from the preceding filtering process (e.g., from FIG. 2G). At block 253, the method includes filtering the output file from Step D for each of a plurality of parameters to determine which parameter yields the largest number of symbols in common with the output file from Step D. The evaluated parameters may include: IBD-RsG80, IBD-RsG40toL80, IBD-RsG20toL40, IBD-RsG10toL20, and IBD-RsLe10.

At block 254, it is determined whether only one parameter yields the highest number of symbols in common with the output file from Step D. If only one parameter yields the highest number, the method proceeds to block 249, where the output file from Step D is filtered using that parameter to create a new output file for Step E. If multiple parameters yield the same highest number of matching symbols, the method proceeds to block 255, where it is determined whether any of the parameters has a higher FileUnderTest backtest score compared to the others. If so, the method proceeds to block 250, where the output file from Step D is filtered using that parameter to create the output file for Step E. If none of the parameters has a higher backtest score, the method proceeds to block 248, where the parameter having the highest IBD ranking (in decreasing order: RsG80, RsG40toL80, RsG20toL40, RsG10toL20, RsLe10) is selected for filtering.

Following parameter selection, the method proceeds to either block 249, block 250, or block 251, where the output file from Step D is filtered using the selected parameter to generate the output file for Step E. After filtering, the method proceeds to block 256, where it is determined whether the resulting list still contains more than five (5) symbols. If more than five symbols remain, the method moves to Step F at block 252 for further refinement. If the list contains five or fewer symbols, the method proceeds to block 257, where the final filtered list is produced. Thus, FIG. 2H illustrates a systematic decision-making process for selecting an optimal parameter based on symbol overlap, backtest performance, and IBD ranking in order to generate a final refined stock symbol list for trading analysis.

As shown in FIG. 2I, a method for refining a filtered list of stock symbols based on comparative ranking parameters is illustrated, according to some embodiments of the present disclosure. The method begins at block 258, where Step F is entered from the preceding filtering process (e.g., from FIG. 2H). At block 259, the method includes filtering the output file from Step E based on several parameters to determine which parameter yields the largest number of symbols in common with the output file from Step E. The evaluated parameters may include: IBD-CompG80, IBD-CompG40toL80, IBD-CompG20toL40, IBD-CompG10toL20, and IBD-CompLe10. At block 260, it is determined whether only one parameter yields the highest number of symbols in common with the output file from Step E. If only one parameter yields the highest number, the method proceeds to block 263, where the output file from Step E is filtered using this one parameter to create the output file for Step F. If multiple parameters yield the same highest number of matching symbols, the method proceeds to block 261, where it is determined whether any one of these parameters has a higher FileUnderTest backtest score compared to the others. If one parameter does have a higher backtest score, the method proceeds to block 264, where the output file from Step E is filtered using that parameter to create the output file for Step F.

If none of the parameters has a higher backtest score, the method proceeds to block 262, where the parameter with the higher IBD rating (in decreasing order: CompG80, CompG40toL80, CompG20toL40, CompG10toL20, CompLe10) is selected. Following selection of the appropriate filtering parameter, the method proceeds to either block 263, block 264, or block 265, where the output file from Step E is filtered to produce the updated output file for Step F. After filtering, the method proceeds to block 266, where it is determined whether the resulting list contains more than five (5) symbols. If more than five symbols remain, the method moves to Step G at block 268 for further refinement. If the list contains five or fewer symbols, the method proceeds to block 267, where the final filtered list is produced. Thus, FIG. 2I illustrates a structured filtering method based on symbol overlap, backtesting performance, and comparative ranking values to systematically generate a highly refined stock list for use in targeted trading strategies.

As shown in FIG. 2J, a method for refining a filtered list of stock symbols based on group ranking parameters is illustrated, according to some embodiments of the present disclosure. The method begins at block 269, where Step G is entered from the preceding filtering process (e.g., from FIG. 2I). At block 270, the method includes filtering the output file from Step F for each of a plurality of parameters to determine which parameter yields the largest number of symbols in common with the output file from Step F. The evaluated parameters may include: IBD-GrpRsPos and IBD-GrpRsNeg.

At block 271, it is determined whether only one parameter yields the highest number of symbols in common with the output file from Step F. If only one parameter yields the highest number, the method proceeds to block 274, where the output file from Step F is filtered using this one parameter to create the output file for Step G. If multiple parameters yield the same highest number of matching symbols, the method proceeds to block 272, where it is determined whether any one of the parameters has a higher FileUnderTest backtest score compared to the others. If one parameter has a higher backtest score, the method proceeds to block 275, where the output file from Step F is filtered using that parameter to create the output file for Step G. If none of the parameters has a higher backtest score, the method proceeds to block 273, where the parameter with the higher IBD rating (in decreasing order: GrpRsPos, GrpRsNeg) is selected.

Following parameter selection, the method proceeds to either block 274, block 275, or block 276, where the output file from Step F is filtered using the selected parameter to produce the updated output file for Step G. After filtering, the method proceeds to block 277, where it is determined whether the resulting filtered list contains more than five (5) symbols. If more than five symbols remain, the method moves to Step H, at block 279 for further refinement. If the list contains five or fewer symbols, the method proceeds to block 278, where the final filtered list is produced. Thus, FIG. 2J illustrates a final-stage selection process using group relative strength parameters, backtesting performance, and ranking to produce a refined stock symbol list optimized for trading.

FIG. 2K illustrates a method for final refinement of a filtered list of stock symbols based on group relative strength parameters is illustrated, according to some embodiments of the present disclosure. The method begins at block 280, where Step H is entered from the preceding filtering process (e.g., from FIG. 2J). At block 281, the method includes filtering the output file from Step G based on several parameters to determine which parameter yields the largest number of symbols in common with the output file from Step G. The evaluated parameters may include: IBD-GrpRsG80, IBD-GrpRsG40toL80, IBD-GrpRsG20toL40, IBD-GrpRsG10toL20, and IBD-GrpRsLe10. At block 282, it is determined whether only one parameter yields the highest number of symbols in common with the output file from Step G. If only one parameter yields the highest number, the method proceeds to block 285, where the output file from Step G is filtered using this one parameter to create the output file for Step H.

If multiple parameters yield the same highest number of matching symbols, the method proceeds to block 283, where it is determined whether any one of the parameters that yielded the highest symbol count has a higher FileUnderTest backtest score compared to the others. If one parameter has a higher backtest score, the method proceeds to block 286, where the output file from Step G is filtered using that parameter to generate the output file for Step H. If none of the parameters has a higher backtest score, the method proceeds to block 284, where the parameter with the highest IBD ranking (in decreasing order: GrpRsG80, GrpRsG40toL80, GrpRsG20toL40, GrpRsG10toL20, GrpRsLe10) is selected. Following parameter selection, the method proceeds to either block 285, block 286, or block 287, where the output file from Step G is filtered using the selected parameter to produce the updated output file for Step H. The method proceeds to block 288, where the final filtered list is produced based on the selected filtering operation. Thus, FIG. 2K illustrates the final decision-making stage for producing a highly refined and trading-ready stock symbol list based on group relative strength analysis, backtest validation, and hierarchical ranking criteria.

As shown in FIG. 2L, a display screen 289 for stock monitoring, tracking, and filtering is illustrated, according to some embodiments of the present disclosure. At block 289, the display screen may include a variety of visual components for presenting real-time and historical stock data. In some embodiments, the display screen may feature a primary chart area for visualizing stock performance over time, such as daily or intraday percentage changes. The display may include an area for presenting moving averages, price thresholds, and relative strength comparisons for selected stocks.

In some embodiments, the display screen 289 may also provide an interactive selection menu where users can filter stocks based on pre-established criteria such as trading volume, percentage change from low, or IBD (Investor's Business Daily) performance rankings. The display may include dedicated areas for user input fields, graphical sliders, and clickable options that allow dynamic updating of the filtered stock lists. In some embodiments, the display screen 289 may further include visual indicators showing the status of different filtering stages, such as whether a stock has passed the primary, secondary, or tertiary filtering levels. A portfolio tracking area may be presented alongside graphical plots to track selected stocks against various technical indicators, benchmarks, or historical performance curves. The display may also incorporate calendar elements for selecting specific trading days and retrieving corresponding stock data, as well as summary panels listing key metrics such as high price, low price, close price, trading volume, and computed percentage changes. Thus, FIG. 2L illustrates an integrated stock monitoring and filtering interface that enables users to visualize, track, and dynamically refine lists of stocks based on a combination of real-time performance data and predefined screening parameters.

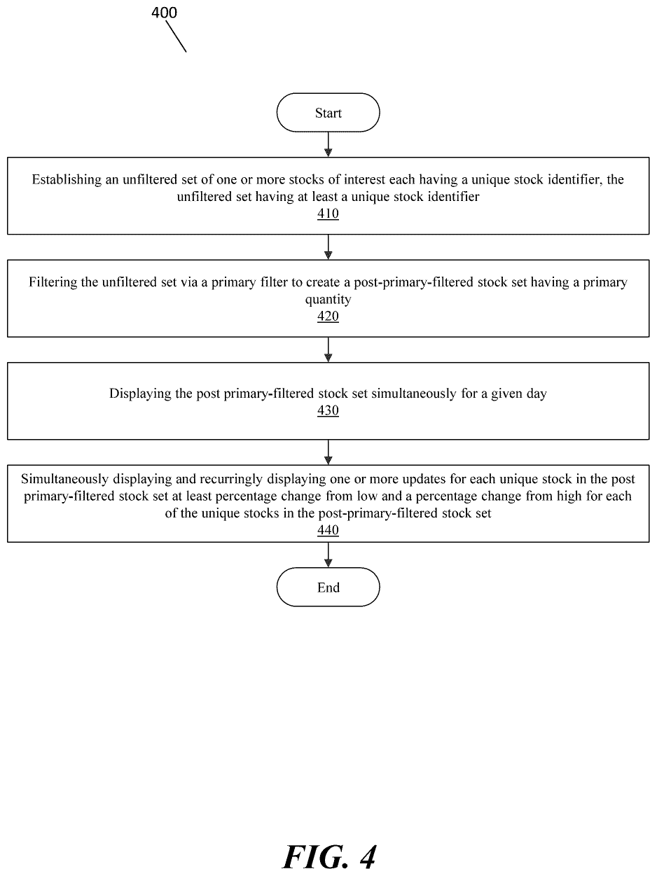

FIG. 4 is a flowchart 400 illustrates a method for targeted stock monitoring and trading, according to some embodiments of the present disclosure. At block 410, the method may include establishing an unfiltered set of one or more stocks of interest, wherein each stock has a unique stock identifier. The unfiltered set includes at least one unique stock identifier and may include a greater number of stocks depending on predefined criteria or lists such as daily market watchlists or sector-specific groups. At block 420, the method may include filtering the unfiltered set via a primary filter to create a post-primary-filtered stock set having a primary quantity. In some embodiments, the primary filter may be based on performance criteria such as average close-to-low percentage changes, moving averages, or trading volume thresholds. The primary quantity may limit the number of stocks retained in the post-primary-filtered stock set, for example to a maximum of five (5) symbols for further tracking.

At block 430, the method may include displaying the post-primary-filtered stock set simultaneously for a given day. In some embodiments, the displayed list provides users with a refined, focused selection of stocks that meet the primary filtering criteria, enabling efficient monitoring. At block 440, the method may include simultaneously displaying and recurringly updating one or more performance metrics for each unique stock in the post-primary-filtered stock set. The updates may include at least a percentage change from the low and a percentage change from the high for each unique stock. In some embodiments, these updates are retrieved from real-time or near real-time data feeds and are continuously refreshed throughout the trading session. Thus, FIG. 4 provides a structured method for establishing, filtering, and dynamically monitoring a refined list of stocks based on unique identifiers and performance-based filtering criteria, enabling targeted stock tracking and trading activities.

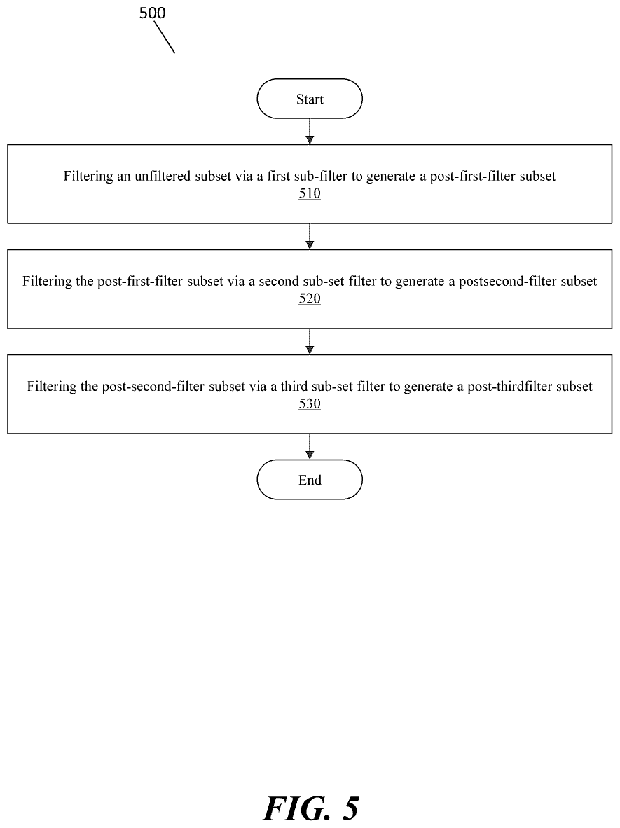

As shown in FIG. 5, a flowchart 500 further illustrates the method for targeted stock monitoring and trading from FIG. 4, according to some embodiments of the present disclosure. At block 510, the method may include filtering an unfiltered subset of stocks via a first sub-filter to generate a post-first-filter subset. In some embodiments, the first sub-filter may apply trading volume thresholds, minimum price change requirements, or other primary screening criteria designed to reduce the number of candidate stocks based on initial performance parameters. At block 520, the method may include filtering the post-first-filter subset via a second sub-filter to generate a post-second-filter subset. In some embodiments, the second sub-filter may incorporate additional or secondary performance metrics, such as relative strength indicators, earnings momentum, volatility measurements, or comparative rankings, to further narrow the selection of stocks. At block 530, the method may include filtering the post-second-filter subset via a third sub-filter to generate a post-third-filter subset. In some embodiments, the third sub-filter may apply tertiary selection criteria, including custom rank orders, historical consistency metrics, or specific intersectional lists derived from external ranking systems such as IBD (Investor's Business Daily). Thus, FIG. 5 illustrates a multi-stage, hierarchical filtering approach that progressively refines an initial unfiltered set of stocks into a smaller, highly-targeted list suitable for active monitoring, display, and potential trading, as discussed with respect to FIG. 4.

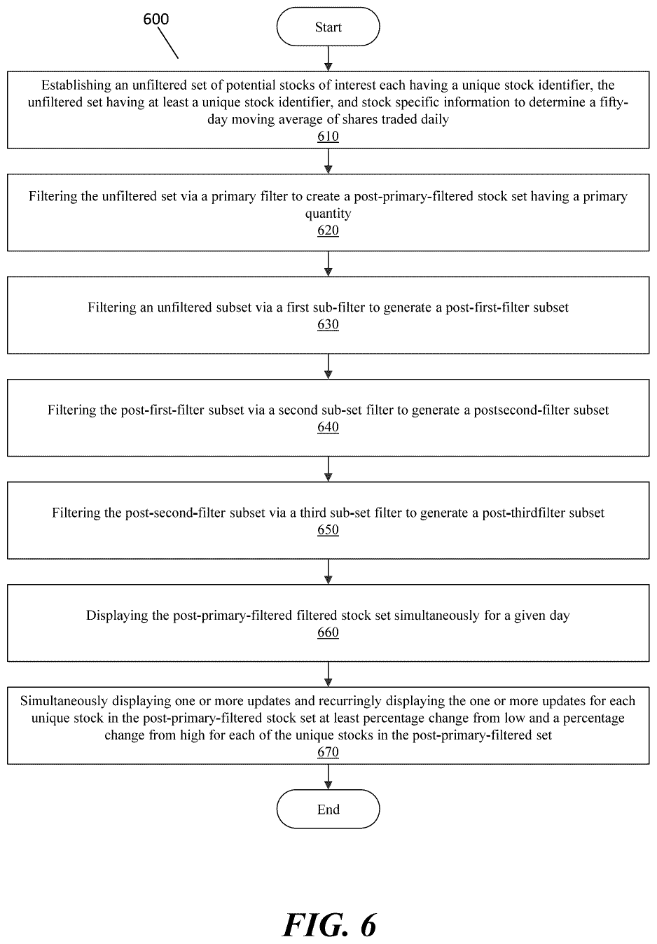

As shown in FIG. 6, a flowchart 600 illustrates a method for targeted stock monitoring and trading, according to some embodiments of the present disclosure. At block 610, the method may include establishing an unfiltered set of potential stocks of interest, where each stock has a unique stock identifier. The unfiltered set may include at least one unique stock identifier, along with stock-specific information such as trading volume, high price, low price, and closing price. In some embodiments, the stock-specific information may be utilized to determine a fifty-day moving average of shares traded daily for each stock. At block 620, the method may include filtering the unfiltered set via a primary filter to generate a post-primary-filtered stock set having a primary quantity. The primary filter may apply performance-based metrics such as price volatility, average close-to-low percentage, or trading volume criteria.

At block 630, the method may include filtering an unfiltered subset via a first sub-filter to generate a post-first-filter subset. In some embodiments, the first sub-filter may target basic eligibility criteria, such as a minimum average daily trading volume threshold. At block 640, the method may include filtering the post-first-filter subset via a second sub-filter to generate a post-second-filter subset. The second sub-filter may apply additional refinement parameters such as technical indicators, performance over a fixed period, or sector-relative performance measures. At block 650, the method may include filtering the post-second-filter subset via a third sub-filter to generate a post-third-filter subset. In some embodiments, the third sub-filter may incorporate custom ranking or backtested scoring methodologies to further prioritize stocks within the subset.

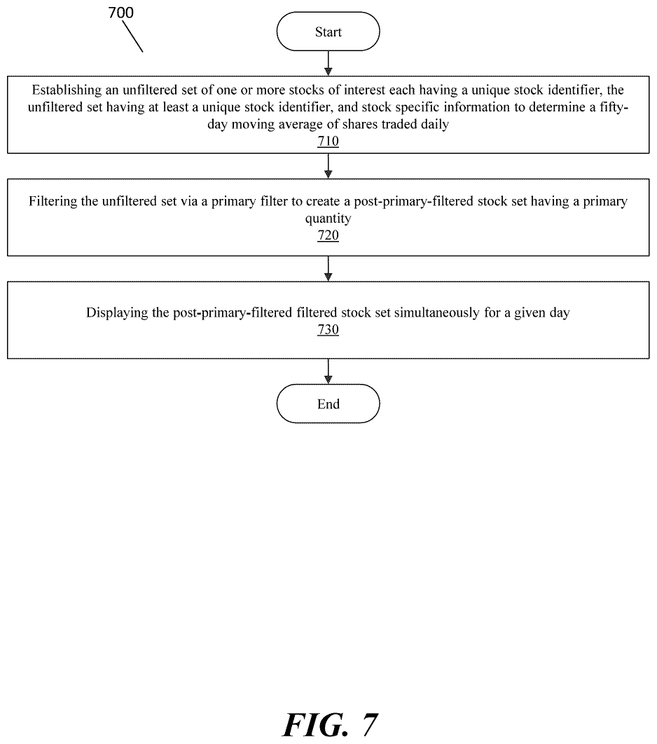

At block 660, the method may include displaying the post-primary-filtered stock set simultaneously for a given day. The display may present stocks that have passed all levels of filtering and are suitable for real-time monitoring and analysis. At block 670, the method may include simultaneously displaying and recurringly updating one or more metrics for each unique stock in the post-primary-filtered stock set. The updates may include, at a minimum, a percentage change from the low and a percentage change from the high for each unique stock, enabling users to monitor intraday performance dynamically. Thus, FIG. 6 illustrates an enhanced, multi-stage method for selecting, refining, and actively monitoring a targeted stock list based on dynamic performance and volume-based criteria. As shown in FIG. 7, a flowchart 700 illustrates a method for targeted stock monitoring and trading, according to some embodiments of the present disclosure.

At block 710, the method may include establishing an unfiltered set of one or more stocks of interest, wherein each stock has a unique stock identifier. The unfiltered set includes at least a unique stock identifier and may also include stock-specific information sufficient to determine a fifty-day moving average of shares traded daily for each stock. In some embodiments, this unfiltered set may be generated from external stock market sources, watchlists, or dynamically updated databases. At block 720, the method may include filtering the unfiltered set via a primary filter to create a post-primary-filtered stock set having a primary quantity. The primary filter may select stocks that meet defined performance, volume, or volatility criteria, thus narrowing the initial unfiltered set to a smaller, more manageable group of stocks. At block 730, the method may include displaying the post-primary-filtered stock set simultaneously for a given day. In some embodiments, the display provides real-time or near real-time tracking of the stocks that have successfully passed the primary filtering process, allowing for focused monitoring and analysis. Thus, FIG. 7 illustrates a streamlined method for stock selection and presentation based on unique identifiers and trading activity parameters, supporting efficient real-time monitoring for trading or investment purposes.

### Systems, Devices and Operating Systems

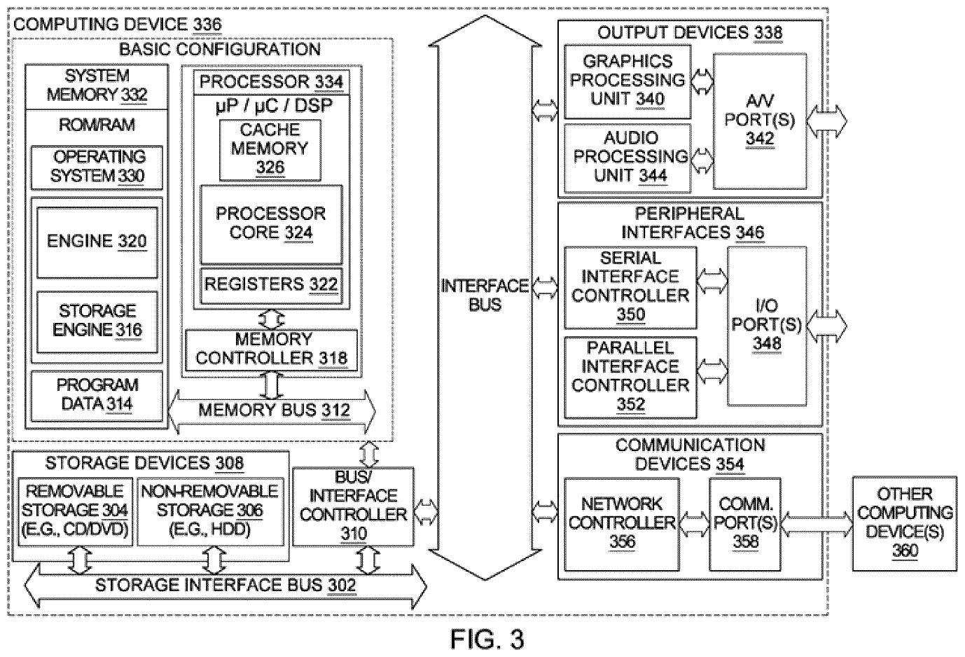

A basic configuration of a computing device 336 (such as the first computing device 220, 222, 224, or 226 of FIG. 1A) is illustrated in FIG. 3 by those components within the inner dashed line. In the basic configuration of the computing device 336, the computing device 336 includes a processor 334 and a system memory 332. The terms “processor” and “central processing unit” or “CPU” are used interchangeably herein. In some examples, the computing device 336 may include one or more processors and the system memory 332. A memory bus 312 is used for communicating between the one or more processors 334 and the system memory 332.

Depending on the desired configuration, the processor 334 may be of any type, including, but not limited to, a microprocessor (μP), a microcontroller (μC), and a digital signal processor (DSP), or any combination thereof. In examples, the microprocessor may be AMD's ATHLON, DURON and/or OPTERON; ARM's application, embedded and secure processors; IBM and/or MOTOROLA's DRAGONBALL and POWERPC; IBM's and SONY's Cell processor; INTEL'S CELERON, CORE (2) DUO, ITANIUM, PENTIUM, XEON, and/or XSCALE; and/or the like processor(s).

Further, the processor 334 may include one more levels of caching, such as a level cache memory 326, a processor core 324, and registers 322, among other examples. The processor core 324 may include an arithmetic logic unit (ALU), a floating point unit (FPU), and/or a digital signal processing core (DSP Core), or any combination thereof. A memory controller 318 may be used with the processor 334, or, in some implementations, the memory controller 318 may be an internal part of the memory controller 318.

Depending on the desired configuration, the system memory 332 may be of any type, including, but not limited to, volatile memory (such as RAM), and/or non-volatile memory (such as ROM, flash memory, etc.), or any combination thereof. The system memory 332 includes an operating system 330, one or more engines, such as an engine 320, and program data 314. In some embodiments, the engine 320 may be an application, a software program, a service, or a software platform, as described infra. The system memory 332 may also include a storage engine 316 that may store any information of data disclosed herein.

The operating system 330 may be a highly fault tolerant, scalable, and secure system such as: APPLE MACINTOSH OS X (Server); AT&T PLAN 9; BE OS; UNIX and UNIX-like system distributions (such as AT&T's UNIX; BERKLEY SOFTWARE DISTRIBUTION (BSD) variations such as FREEBSD, NETBSD, OPENBSD, and/or the like; Linux distributions such as RED HAT, UBUNTU, and/or the like); and/or the like operating systems. However, more limited and/or less secure operating systems also may be employed such as APPLE MACINTOSH OS, IBM OS/2, MICROSOFT DOS, MICROSOFT WINDOWS 2000/2003/3.1/95/98/CE/MILLENNIUM/NT/VISTA/XP (Server), PALM OS, and/or the like. The operating system 330 may be one specifically optimized to be run on a mobile computing device (e.g., one configuration for device 220 FIG. 1A), such as iOS, ANDROID, WINDOWS Phone, TIZEN, SYMBIAN, and/or the like.

As explained supra, the GUI of the device 220 may provide a baseline and means of accessing and displaying information graphically to users. The GUI may include APPLE MACINTOSH Operating System's AQUA, IBM's OS/2, Microsoft's WINDOWS 2000/2003/3.1/95/98/CE/MILLENNIUM/NT/XP/Vista/7 (i.e., AERO), UNIX'S X-Windows (e.g., which may include additional UNIX graphic interface libraries and layers such as K DESKTOP ENVIRONMENT (KDE), MYTHTVand GNU Network Object Model Environment (GNOME)), web interface libraries (e.g., ActiveX, AJAX, (D)HTML, FLASH, JAVA, JAVASCRIPT, etc. interface libraries such as, but not limited to, DOJO, JQUERY(UI), MOOTOOLS, PROTOTYPE, SCRIPT.ACULO.US, SWFOBJECT, or YAHOO! User Interface, any of which may be used.

Additionally, a web browser component (not shown) is a stored program component that is executed by the CPU. The web browser may be a conventional hypertext viewing application such as MICROSOFT INTERNET EXPLORER, EDGE, CHROME, FIREFOX, or NETSCAPE NAVIGATOR. SECURE WEB browsing may be supplied with 128 bit (or greater) encryption by way ofHTTPS, SSL, and/or the like. Web browsers allowing for the execution of program components through facilities such as ACTIVEX, AJAX, (D)HTML, FLASH, JAVA, JAVASCRIPT, web browser plug-in APis (e.g., FIREFOX, SAFARI Plug-in, and/or the like APis), and/or the like. Web browsers and like information access tools may be integrated into PDAs, cellular telephones, and/or other mobile devices.

A web browser may communicate to and/or with other components in a component collection, including itself, and/or facilities of the like. Most frequently, the web browser communicates with information servers, operating systems (such as the operating system 226), integrated program components (e.g., plug-ins), and/or the like; e.g., it may contain, communicate, generate, obtain, and/or provide program component, system, user, and/or data communications, requests, and/or responses. Of course, in place of a web browser and an information server, a combined application may be developed to perform similar functions of both. The combined application would similarly affect the obtaining and the provision of information to users, user agents, and/or the like from the enabled nodes of the present invention.

Moreover, the computing device 336 may have additional features or functionality, and additional interfaces to facilitate communications between the basic configuration and any desired devices and interfaces. For example, a bus/interface controller is used to facilitate communications between the basic configuration and data storage devices via a storage interface bus 302. The data storage devices may be one or more removable storage devices, one or more non-removable storage devices, or a combination thereof. Examples of the one or more removable storage devices and the one or more non-removable storage devices include magnetic disk devices (such as flexible disk drives and hard-disk drives (HDD)), optical disk drives (such as compact disk (CD) drives or digital versatile disk (DVD) drives), solid state drives (SSD), and tape drives, among others. Data stores 230, 232, and 234 are data storage devices shown in FIG. 1A.

In some embodiments, an interface bus facilitates communication from various interface devices (e.g., one or more output devices 338, one or more peripheral interfaces 346, and one or more communication devices 354) to the basic configuration via the bus/interface controller 310. Some of the one or more output devices 338 include a graphics processing unit 340 and an audio processing unit 344, which are configured to communicate to various external devices, such as a display or speakers, via one or more A/V ports 342.

The one or more peripheral interfaces 346 may include a serial interface controller 350 or a parallel interface controller 352, which are configured to communicate with external devices, such as input devices (e.g., a keyboard, a mouse, a pen, a voice input device, or a touch input device, etc.) or other peripheral devices (e.g., a printer or a scanner, etc.) via one or more 1/0 ports 348.

Further, the one or more communication devices 354 may include a network controller 356, which is arranged to facilitate communication with one or more other computing devices 360 over a network 210 communication link via one or more communication ports 358. The one or more other computing devices 360 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 332, the one or more removable storage devices 304, and the one or more non-removable storage devices 306 are examples of the computer-readable storage media. The computer-readable storage media is a tangible device that can retain and store instructions (e.g., program code) for use by an instruction execution device (e.g., the computing device 336). Any such, computer storage media is part of the computing device 336.

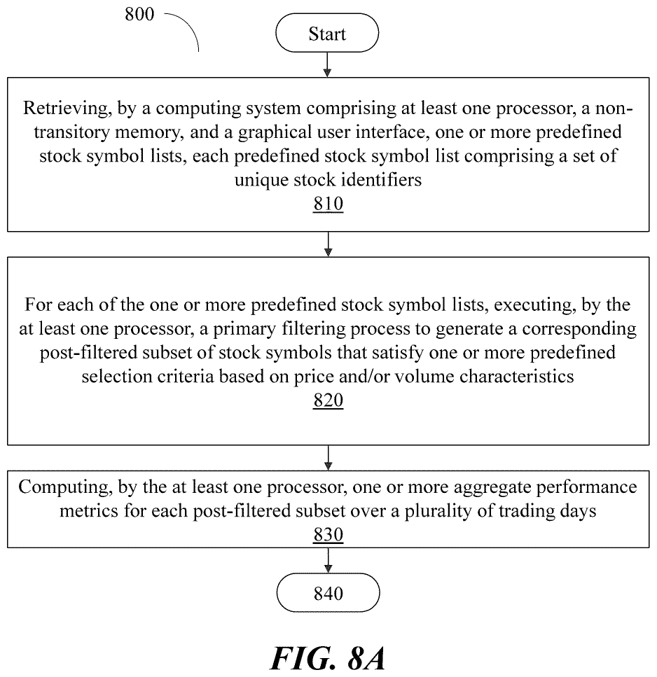

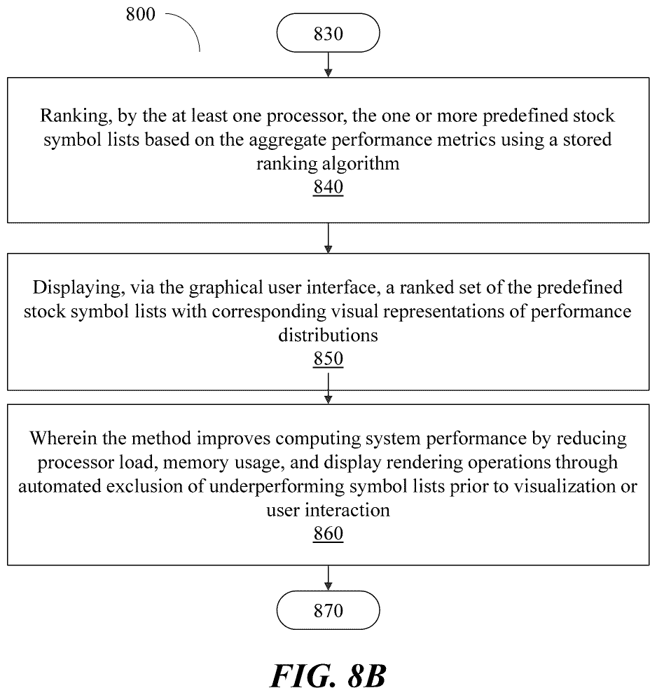

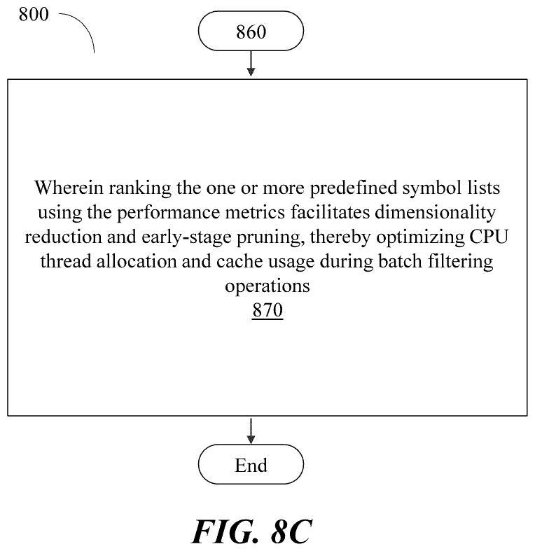

FIG. 8A illustrates a flowchart 800 of a computer-implemented method for identifying high-performing stock symbol lists for targeted trading. The method may be executed by a computing system comprising at least one processor, one or more memory elements, and a graphical user interface (GUI) configured to display and receive user input related to stock symbol list selection and performance analysis.

At block 810, the system retrieves, via the at least one processor, one or more predefined stock symbol lists stored in a non-transitory memory. Each predefined stock symbol list includes a set of unique stock identifiers, such as stock ticker symbols corresponding to publicly traded securities. These symbol lists may be manually curated or programmatically generated from external financial databases or market intelligence platforms. The retrieval may be performed based on a user selection from the GUI or scheduled automation triggered by time or market events.

At block 820, the system executes a primary filtering process for each of the one or more predefined stock symbol lists. This filtering is performed by the at least one processor to generate a corresponding post-filtered subset of stock symbols. The filtering process applies one or more predefined selection criteria, which may include technical indicators such as percentage change in price (e.g., close price to low price), absolute or relative volume change, price momentum thresholds, volatility metrics, or combinations thereof. The filtering ensures that only stock symbols satisfying these criteria are retained in the post-filtered subset. This process may involve real-time or historical price and volume data obtained from financial data feeds or stored datasets.

At block 830, the computing system calculates one or more aggregate performance metrics for each of the generated post-filtered subsets. These metrics may include, but are not limited to, average percentage change (e.g., close-low), maximum intraday movement, volatility-adjusted return, frequency of satisfying filtering criteria, or other statistical indicators computed across a plurality of trading days. The computed metrics enable the system to assess the performance of each subset over time, identify high-performing lists, and assist traders or analysts in decision-making.

Referring now to FIG. 8B, an embodiment of the method 800 continues from the step of computing aggregate performance metrics, as previously described with respect to FIG. 8A. At step 840, the computing system comprising at least one processor accesses a stored ranking algorithm to automatically rank the one or more predefined stock symbol lists based on the computed aggregate performance metrics. These aggregate performance metrics may include, but are not limited to, average percentage change between closing price and daily low, maximum percentage change within a filtered symbol subset, or cumulative return across a specified trading period. The ranking algorithm may apply a weighted scoring function, percentile-based ordering, or other statistical sorting operation to prioritize symbol lists demonstrating higher historical performance over the testing period.

At step 850, the ranked set of symbol lists is displayed via the graphical user interface. Each entry in the ranked set may be visually represented by one or more graphical elements, such as bar charts, line plots, tables, or other visual indicators that convey the distribution of underlying performance metrics across multiple trading days. These visual representations assist traders or analysts in quickly identifying symbol lists with favorable characteristics for further exploration or automated trading logic.

At step 860, the system is configured to improve computing performance by selectively excluding underperforming symbol lists from subsequent rendering and user interaction workflows. This automated exclusion reduces unnecessary processor load, minimizes memory allocation, and eliminates redundant rendering operations for lists that fail to meet baseline performance thresholds. As a result, the system optimizes visual responsiveness and computational efficiency, particularly in environments involving large-scale symbol list evaluation over extended date ranges.

Referring now to FIG. 8C, the method 800 further includes an optimization stage performed after ranking the one or more predefined stock symbol lists using the computed performance metrics. At step 870, the ranking operation is leveraged to facilitate dimensionality reduction within the computing system by identifying and retaining only a reduced subset of symbol lists that satisfy predefined performance thresholds. Symbol lists that fall below the thresholds are excluded from subsequent processing stages, thereby reducing the dimensionality of the dataset prior to execution of additional filtering or analysis operations.

This early-stage pruning enables the computing system to allocate CPU threads more efficiently by limiting concurrent processing to symbol lists that are statistically more likely to produce qualifying symbols. As a result, batch filtering operations are executed across a smaller working set, reducing thread contention and avoiding unnecessary context switching. Additionally, the reduced dataset improves processor cache utilization by increasing temporal and spatial locality of accessed data structures associated with the retained symbol lists. By constraining batch filtering operations to a pruned and ranked subset of symbol lists, the system minimizes repeated memory fetches and cache evictions that would otherwise occur when processing large volumes of low-value data. This approach improves overall throughput and execution efficiency during high-frequency or multi-day filtering workflows, and allows the computing system to scale to larger symbol universes while maintaining predictable performance characteristics.

In some embodiments, the graphical user interface (GUI) dynamically presents a ranked set of predefined stock symbol lists, wherein each list represents a subset of stock symbols filtered based on predefined selection criteria. The ranking is performed by at least one processor based on aggregate performance metrics computed for each list over a historical time window, such as at least 250 trading days. The visual representations generated by the system comprise a distribution plot for each of the ranked predefined stock symbol lists. Each distribution plot includes a cumulative line plot representing a running sum of distribution values across the post-filtered subset, thereby visually illustrating performance variability, concentration zones, and relative volatility.

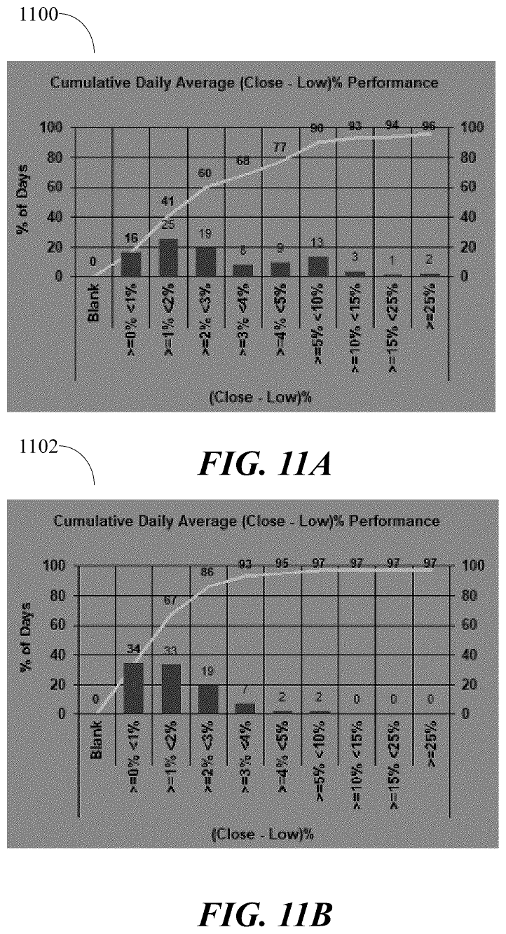

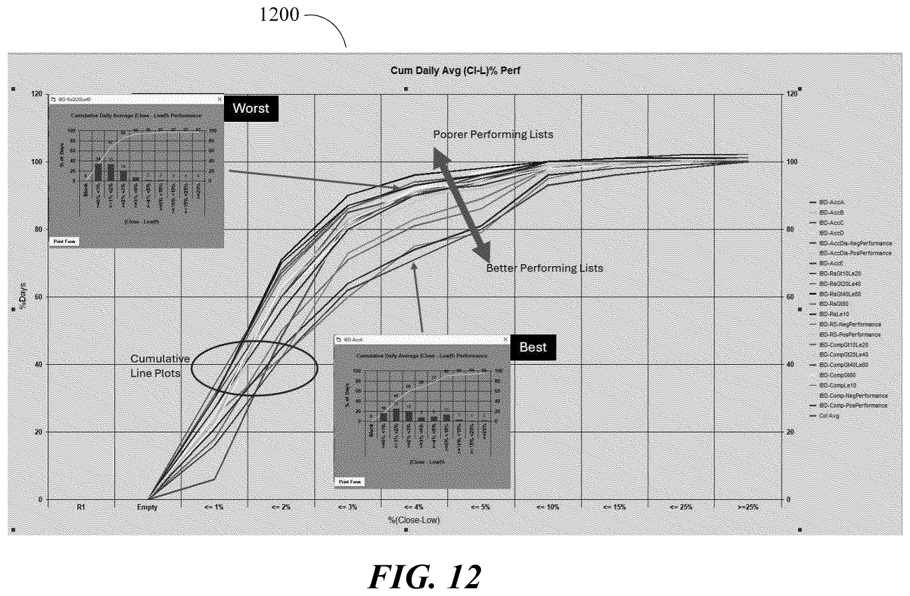

To enhance performance and reduce graphical rendering overhead, the system displays the cumulative line plots for multiple ranked symbol lists on a single canvas within the GUI, as best shown in FIG. 12. This consolidated rendering approach minimizes the number of Document Object Model (DOM) elements in the rendering tree, reducing DOM complexity and GPU workload. This improves frame rate stability and responsiveness during concurrent visualization of symbol list performance data. As a result, users may compare multiple symbol lists in a high-density yet low-latency interface, which improves decision-making speed and visual discernment in professional trading contexts.

The predefined selection criteria used for primary filtering of stock symbols may include ranges of percentage-based price changes, volume changes, or a combination thereof. For example, the range of price changes may include about 20% to about 30%, about 30% to about 40%, or about 40% to about 100%. Similarly, volume change thresholds may include about 800% to about 1600%, about 1600% to about 3200%, or greater than about 3200%. These numeric filters enable high-granularity control over symbol inclusion in each predefined list, ensuring that only statistically significant movement profiles are analyzed during downstream ranking operations.

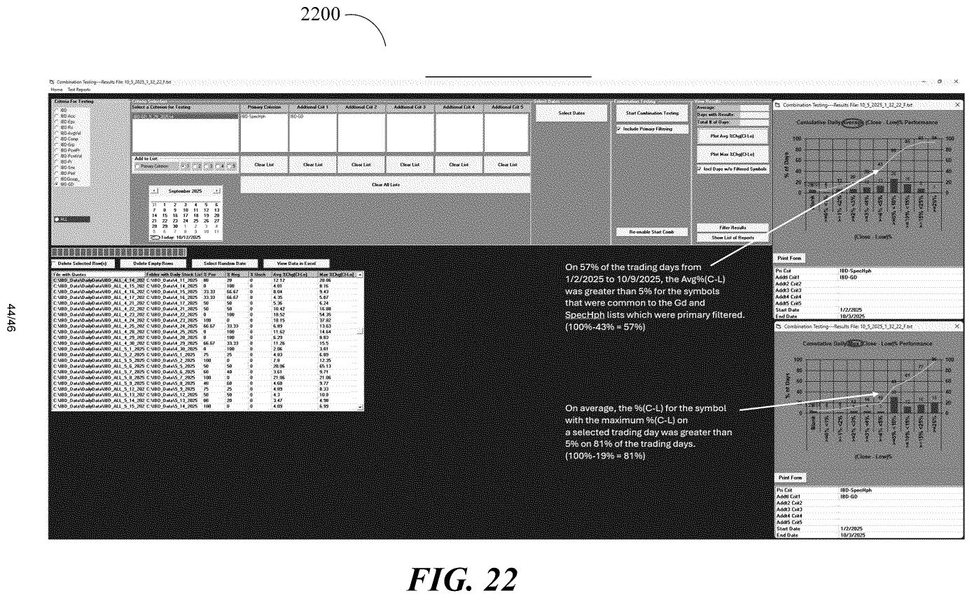

Each list's performance is scored using aggregate performance metrics including historical volatility, daily price fluctuation magnitude, and directional price shift magnitude. These metrics are visualized in bar charts or distribution plots to assist users in interpreting list behavior over time, as best shown in FIG. 22. Additionally, an automated backtest module may be executed by the processor to evaluate each symbol list's performance across a historical window, producing a visual summary that includes a range distribution plot and a maximum value indicator. To facilitate efficient system resource utilization, the processor constrains the primary filtering process for each symbol list to produce a post-filtered subset that does not exceed a defined maximum number of symbols. Moreover, to improve contextual relevance for end users, the system may identify symbols that appear in both a post-filtered subset and a predefined global dataset (e.g., a user's watchlist), and prioritize their display within the GUI.

In order to reduce decision latency and network overhead, the system refreshes the ranked symbol lists on a daily basis using updated end-of-day market data received from external public data feeds. The ranking process is performed server-side, and only top-tier visualization data is transmitted to the client device. This approach minimizes bandwidth usage and ensures rapid interface responsiveness, particularly beneficial in low-connectivity environments or bandwidth-constrained devices.

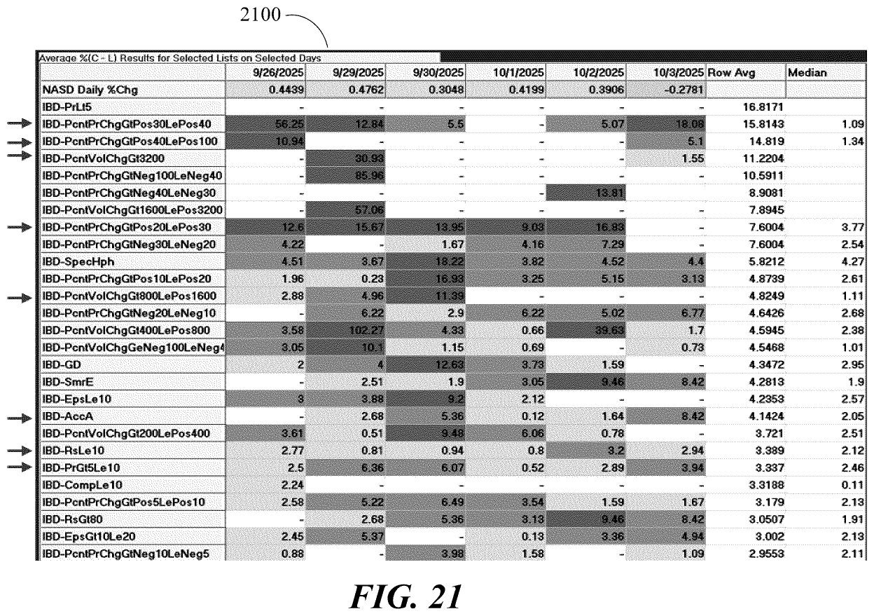

In some embodiments, dynamic list selection may be applied wherein symbol lists for ranking are selected based on overlap with one or more user-defined lists, as best shown in FIG. 21. The GUI presents the final ranked lists in visual priority order to support faster cognitive parsing and selection by the user, thereby reducing interface congestion and improving user experience.

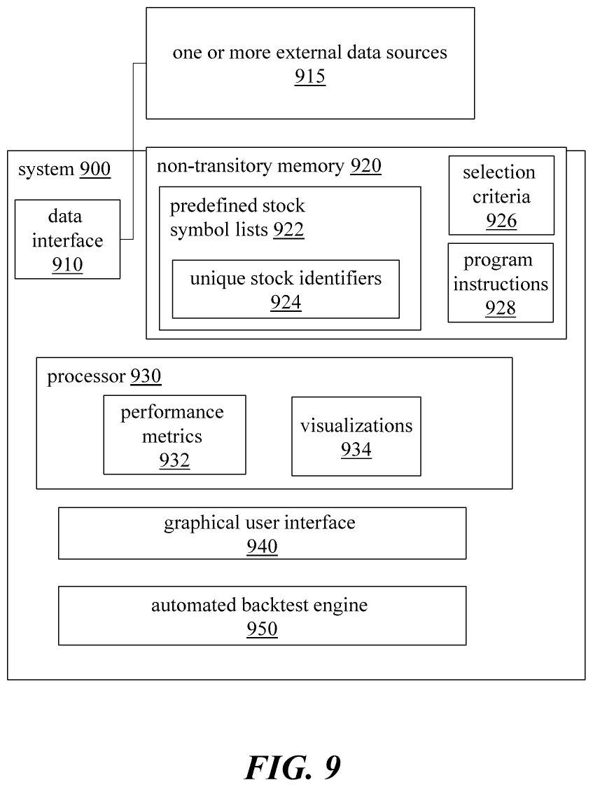

FIG. 9 illustrates an embodiment of a system 900 for filtering, ranking, and displaying high-performing stock symbol lists. The system 900 includes a data interface 910, a non-transitory memory 920, at least one processor 930, a graphical user interface (GUI) 940, and an automated backtest engine 950. The system is communicatively coupled with one or more external data sources 915 that provide up-to-date stock market data, including price and volume information for a plurality of stock symbols. The data interface 910 is configured to retrieve the price and volume data for stock symbols from the external data sources 915. These sources may include third-party financial APIs, cloud-hosted datasets, or private market data subscriptions. Once retrieved, the data is made available to the remaining components of the system for real-time or batch analysis.

The non-transitory memory 920 stores several key data structures and executable program instructions. In one embodiment, the memory 920 stores one or more predefined stock symbol lists 922, where each list comprises one or more unique stock identifiers 924 corresponding to publicly traded equities or exchange-traded products. These symbol lists may represent thematic investment strategies, such as momentum stocks, sector-specific baskets, or user-curated watchlists. Additionally, the memory 920 stores selection criteria 926 that define how the stock symbols are to be filtered. These criteria may include percentage thresholds for daily price change, absolute or relative volume surges, moving average crossovers, or other configurable financial signals. The program instructions 928 stored in memory include logic for applying the selection criteria to each stock symbol list, computing performance metrics, and preparing display data for the GUI 940.

The processor 930 is configured to execute the program instructions 928 to perform various data processing operations. When new data is retrieved through the data interface 910, the processor applies a primary filtering operation to each predefined stock symbol list 922 based on the selection criteria 926. This filtering step generates a post-filtered subset of stock symbols for each list, thereby excluding symbols that do not meet the specified thresholds. After filtering, the processor computes one or more aggregate performance metrics 932 for each post-filtered subset. These metrics may include, but are not limited to, average daily return, cumulative return over a defined period, Sharpe ratio, or volatility measures. Using these computed metrics, the processor then ranks the symbol lists in order of relative performance. Based on the ranking, the processor generates display data comprising visualizations 934 of the highest-performing symbol lists. The display data may include performance trend charts, comparative bar graphs, or distribution plots showing the variability or consistency of list-based returns.

The graphical user interface 940 is configured to render the generated visualizations for user review. Importantly, to reduce computational load and rendering complexity, the system is configured to exclude underperforming symbol lists from being processed for visualization. This selective rendering approach reduces unnecessary graphical rendering overhead and optimizes both memory usage and rendering pipeline efficiency. As a result, the user interface remains responsive, and system resources are conserved, particularly when many symbol lists are evaluated in parallel.

In some embodiments, the processor 930 is further configured to operate an automated backtest engine 950. The backtest engine evaluates the historical performance of individual stock symbol lists or combinations thereof across a user-specified or automatically defined range of trading days. During the back testing process, the system applies historical versions of the selection criteria 926 to simulate how the filtered symbol lists would have performed over the selected period. The resulting performance summaries may include cumulative return graphs, frequency-based success rates, and time-distributed profit and loss (P&L) summaries. These summaries are then rendered via the GUI 940 to provide users with a historical basis for strategy selection or refinement. Thus, the described system 900 improves the efficiency and technical functioning of data processing and rendering systems by limiting unnecessary downstream computations through early filtering of underperforming candidates. Unlike conventional systems that process and visualize all available data regardless of its relevance, the present system leverages selection logic and performance metrics to streamline operations. This contributes to reduced processor cycles, minimized graphical rendering latency, and improved throughput in real-time trading environments.

FIG. 10 illustrates a performance-based method for selecting stock symbol lists for targeted filtering and trading. The figure presents a comparative table 1000 of average daily percentage change from closing price to low price (%Ch(C-L)) across multiple predefined stock symbol lists that have already been processed through a primary filtering stage. The table includes data for selected trading dates, September 26, 29, and 30 and October 1 through 3 of the year 2025, covering up to six days of historical performance data for each symbol list. Each row in the table corresponds to a different predefined list, such as “IBD-AccA,” “IBD-RsLe10,” “IBD-CompG10Le20,” and so forth. Each column shows the average %Ch(C-L) value for the corresponding list on a given date, with additional columns displaying the row average and median for each list across the sampled dates. The lists are ranked in descending order based on the row average of %Ch(C-L), allowing for immediate visual identification of the top-performing symbol lists. For example, lists such as “IBD-AccA” and “IBD-RsLe10” demonstrate relatively high average daily returns, making them strong candidates for further analysis or trading actions.

This visualization technique enables traders or algorithmic systems to prioritize stock symbol lists that consistently exhibit stronger intraday performance as measured by the %Ch(C-L) metric. By evaluating average behavior over multiple days, the system assists in identifying symbol lists that are more likely to produce favorable outcomes when subjected to additional screening criteria or trading algorithms. The method illustrated in FIG. 10 also supports system performance optimization by focusing computing resources on the most promising candidate lists, thereby reducing the load associated with evaluating underperforming lists. Additionally, this technique can be implemented in conjunction with the automated methods described in earlier figures for filtering, ranking, and display of stock performance data.

The method illustrated in FIG. 10 provides multiple technical benefits that improve the operation of the underlying computing system. First, by pre-filtering stock symbol lists and computing average daily % change (Close-Low) performance metrics across multiple trading sessions, the method enables early exclusion of low-performing symbol lists. This reduces the number of symbol lists requiring further computation, analysis, and rendering, thereby decreasing processor load and conserving memory bandwidth. Second, the tabular visualization enables a ranked presentation of symbol lists based on historical post-filter performance, allowing the system to selectively update only the top-performing lists for future display or user interaction. This prioritization mechanism reduces graphical user interface (GUI) rendering operations and avoids unnecessary redraws or computations related to less relevant data, thereby improving GUI responsiveness and minimizing system latency.

Third, the system benefits from reduced storage and I/O overhead by leveraging aggregated performance metrics instead of raw tick-level market data. This summary-based approach limits the volume of data processed during ranking and display, which is particularly advantageous when operating under real-time or resource-constrained conditions, such as on mobile or embedded trading platforms. Accordingly, the disclosed method introduces a non-conventional improvement in computing system efficiency through selective data reduction, prioritized rendering, and pre-aggregated performance metrics, thereby addressing and overcoming challenges associated with computational bottlenecks and interface congestion in dynamic trading environments.

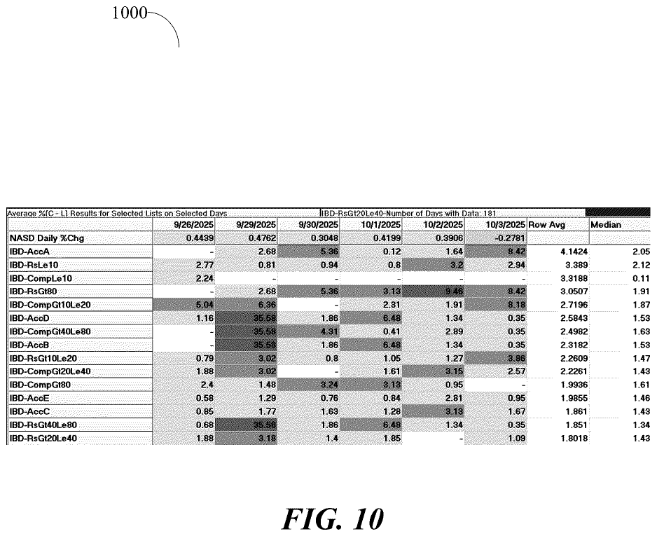

Referring now to FIGS. 11A and 11B, each plot provides a graphical visualization of performance metrics for a respective filtered stock symbol list derived from the aggregated dataset of FIG. 10. The horizontal axis of each plot represents discrete percentage change ranges between the daily close price and low price (Close-Low %) across multiple trading sessions in 2025. These ranges span from “<10%” to “≥25%” in discrete increments, including specific bins such as “≥15% <20%” and “≥20% <25%”.

The vertical bars represent the frequency of occurrence, in percentage of days, that the filtered symbols in a given list fell within each Close-Low % range. Adjacent to the bars, a cumulative line plot overlays the bar chart, providing a running sum of the total daily occurrences progressing across the x-axis from left to right. The cumulative line reaches 100% at the far right, confirming inclusion of all relevant daily records.

FIG. 11A shows an example of a higher-performing list 1100 (e.g., the IBD-AccA list), characterized by a higher proportion of trading days with elevated Close-Low % values. This is visually confirmed by the presence of taller bars toward the right side of the graph and a cumulative curve that steeply ascends. In contrast, FIG. 11B illustrates a lower-performing list 1102 (e.g., the IBD-RsGt20Le20 list), with the majority of bar heights concentrated in lower performance bins, resulting in a flatter cumulative line plot. An ideal output for such bar chart distributions would include a dominant bar located at or beyond the “>25%” Close-Low % mark, indicating that all trading days consistently yielded strong returns. While such ideal cases are not observed in practice, the objective is to identify symbol lists with histogram peaks and cumulative curves that are skewed rightward, signifying stronger filtered symbol performance and thus more desirable for ranking and visualization. These graphical outputs provide analysts with intuitive, quantitative insight into list performance, aiding in the rapid selection of high-performing stock symbol lists for further automated or manual trading analysis. The inclusion of both frequency and cumulative data enables dual-layer validation of filtering effectiveness for each list.

Referring now to FIG. 12, a composite graphical display 1200 is shown in which cumulative performance line plots corresponding to multiple predefined stock symbol lists are concurrently rendered on a single display surface. Each cumulative line plot represents an aggregated progression of performance values derived from spreadsheet data generated during a primary filtering process applied to each respective stock symbol list over a defined range of trading days. The horizontal axis of the chart represents increasing performance bins associated with percentage-based price change ranges between daily close and low prices, while the vertical axis represents a cumulative percentage of trading days in which symbols from a given list fell within or below the corresponding performance ranges. Each line therefore reflects a running cumulative sum of daily performance occurrences for a particular list.

By displaying all cumulative line plots together, the system enables direct visual comparison of multiple list performances without requiring sequential chart navigation or manual spreadsheet inspection. Stronger-performing lists are identified by cumulative curves that remain lower toward the right side of the chart, indicating a higher proportion of trading days achieving elevated performance ranges. Conversely, weaker-performing lists exhibit cumulative curves that rise earlier and more steeply, reflecting concentration of outcomes in lower performance bins. Annotated regions within FIG. 12 illustrate relative performance groupings, including poorer-performing lists, better-performing lists, and best-performing lists, allowing rapid visual differentiation. This simultaneous display reduces cognitive and computational overhead by consolidating comparative analysis into a single rendering operation, facilitating faster identification of higher-quality symbol lists for subsequent filtering, monitoring, or trading operations. The graphical approach of FIG. 12 thus provides an efficient mechanism for evaluating relative list quality across large datasets, improving system usability and analytical throughput when processing multiple symbol lists derived from automated primary filtering.

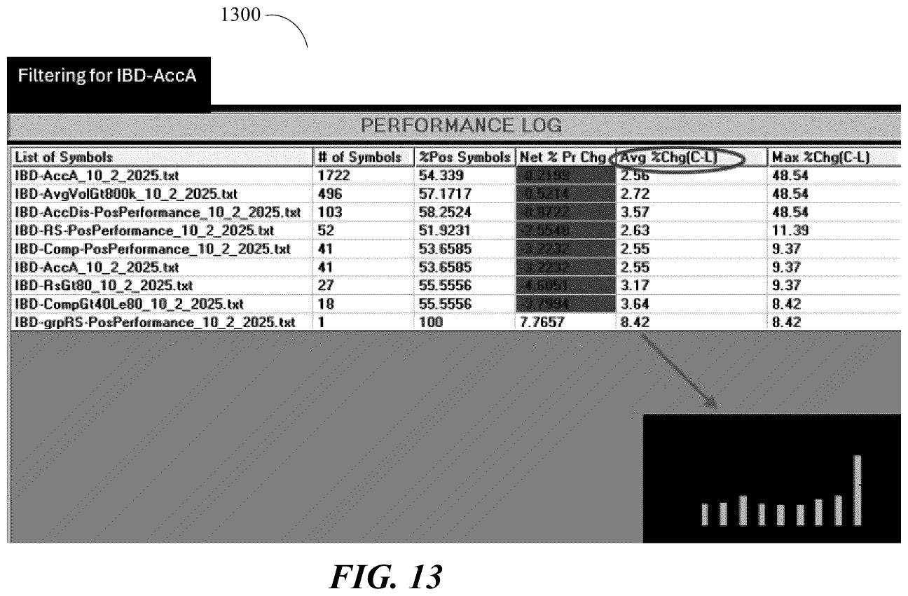

FIG. 13 illustrates a computer-generated performance log interface 1300 configured for evaluating stepwise filtering effects on stock symbol lists using a metric denoted as average percent change from Close to Low (Avg %Chg(C-L)). The vertical arrangement of the table represents an ordered progression of filtering steps applied to an original stock symbol list referred to as “IBD-AccA,” a symbol list derived from an investment database as of Oct. 3, 2025. Each row corresponds to a specific stage in the filtering pipeline, beginning with an unfiltered list and proceeding through successive refinement stages based on criteria such as recent outperformance, risk group tiering, and technical configuration.

The column labeled “Avg %Chg(C-L)” captures the mean value of the percent change from the daily closing price to the daily low across all symbols remaining after each filter step. As the filtering progresses, the number of symbols reduces (as shown in the “#of Symbols” column), while the corresponding Avg %Chg(C-L) increases, culminating in a final filtered list with a significantly higher performance metric (e.g., from 2.56% to 8.42%). A visual highlight and inset bar graph provide a graphical representation of the stepwise performance improvement. The system automatically highlights the best-performing filtering configuration, enabling rapid identification of high-potential symbol subsets. The interface thus provides a real-time, dynamically updated analytical tool for evaluating and comparing performance outcomes of various filtering strategies across symbol lists.

The disclosed system improves the functioning of a computing device by enhancing the efficiency and accuracy of data filtering, scoring, and visualization processes related to financial performance metrics such as average percent change between Close and Low prices, Avg percent Chg C comma L. Through a structured visual analytics engine and a sequential filtering framework, the system transforms symbol list data stored in spreadsheet form into dynamically generated bar plots and cumulative line graphs within a graphical user interface. These transformations reduce the reliance on manual spreadsheet operations and static file-based analysis workflows, thereby minimizing latency and computational overhead associated with repetitive data processing.

The system enables in-memory computation of tiered filtering stages and the corresponding visual outputs without requiring additional user input or spreadsheet recalculations. This enhances the responsiveness and processing throughput of the underlying computing platform. The capability to display multiple cumulative line charts simultaneously further enables side-by-side comparative analysis across different symbol lists, aiding in efficient decision-making while avoiding redundant data loading or visualization rendering. By automating data extraction, facilitating real-time visual analytics, and integrating symbol list performance evaluation into a single streamlined interface, the system allocates memory and processor resources more effectively. These improvements allow the computing device to operate with greater performance and less manual intervention in the context of financial screening workflows. The technical features described herein apply structured computational techniques that improve the usability and resource efficiency of the computing environment.

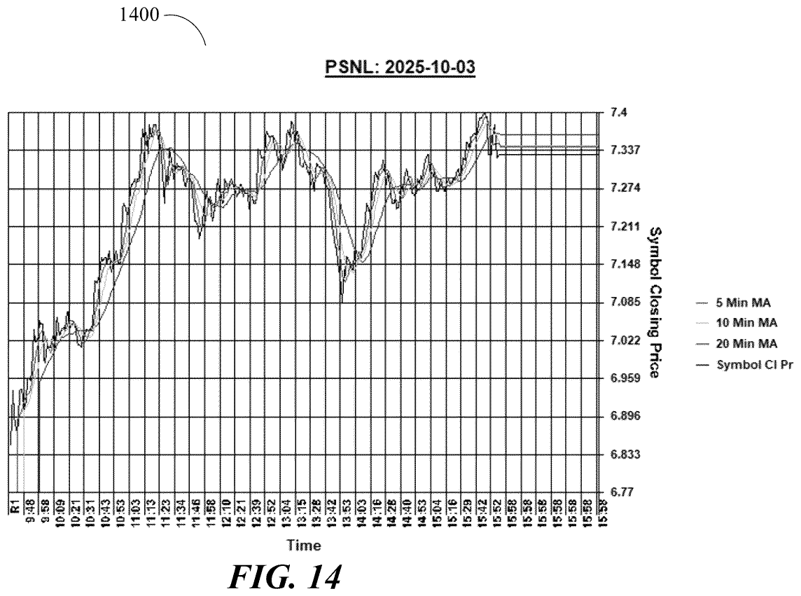

FIG. 14 illustrates a graphical plot 1400 depicting the time-based performance of a single symbol selected by the Primary Filter on Oct. 3, 2025. The vertical axis represents the symbol closing price, while the horizontal axis reflects time intervals spanning from 09:31 to 15:58 on the specified trading day. The symbol corresponds to the AccA list entry identified through the filter, providing a data-driven visualization of intra-day price behavior. Superimposed on the price trajectory are moving average lines including a 5-minute moving average (MA), a 10-minute MA, and a 20-minute MA. These overlays enable comparative trend analysis and momentum evaluation. The symbol's performance trend is distinguished from the averages by a separate line marking the real-time closing prices. This figure enables evaluation of short-term volatility, filter accuracy, and momentum consistency, offering validation for the Primary Filter's efficacy in isolating high-performing candidates. The time series trend provides real-time support for symbol selection, performance tracking, and visualization of price movement dynamics.

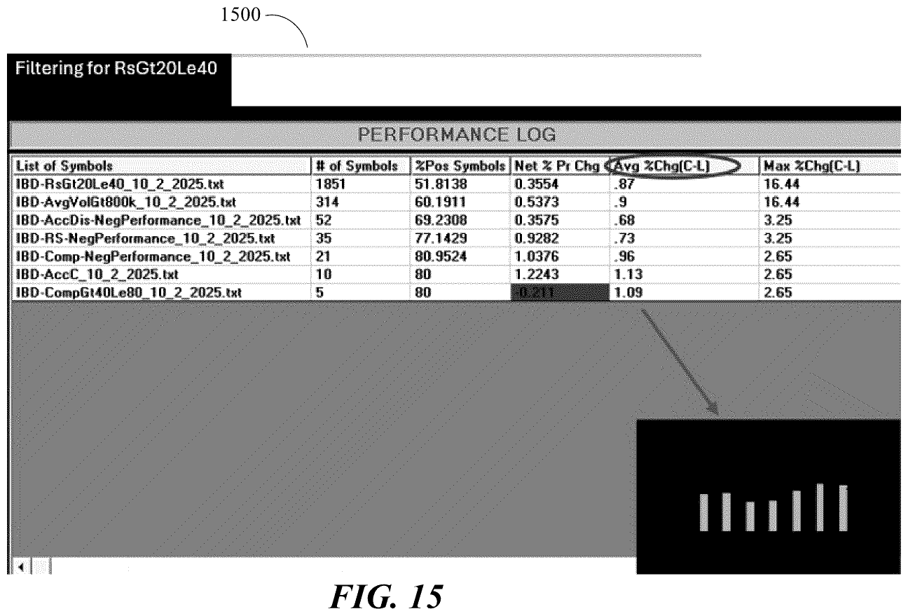

Referring now to FIG. 15, a performance log 1500 is depicted, representing the Primary Filtering results of a symbol set filtered by the RsGt20Le40 condition. The performance log table displays several columns, including a column for the maximum percent change between closing and low prices (%Chg C-L), which reflects the top-performing symbol in each filtering step. The performance of the RsGt20Le40 symbol set improved modestly through the Primary Filtering process, increasing the average %Chg (C-L) from 0.87% to 1.09%, as indicated in the circled region within the column labeled “Avg % Chg (C-L).” This change corresponds to a net gain of 0.22 percentage points across the filtering steps. However, the resulting 1.09% final average remains 7.33 percentage points lower than the final average %Chg (C-L) of 8.42% obtained from the Primary Filtering of the IBD-AccA symbol set, as discussed in FIG. 13. The table further shows that five symbols qualified for retention under the Primary Filtering of the RsGt20Le40 set. These five symbols are listed at the bottom of the table, with details such as the associated dates, performance metrics, and symbol lists used. A graphical plot segment at the lower right of FIG. 15 illustrates the trend in average %Chg (C-L) during the filtering steps, visually confirming the limited improvement gained through the RsGt20Le40 filtering pathway. This data visualization enables direct comparison of symbol sets and highlights the differing degrees of efficacy in identifying high-momentum candidates under various initial list conditions.

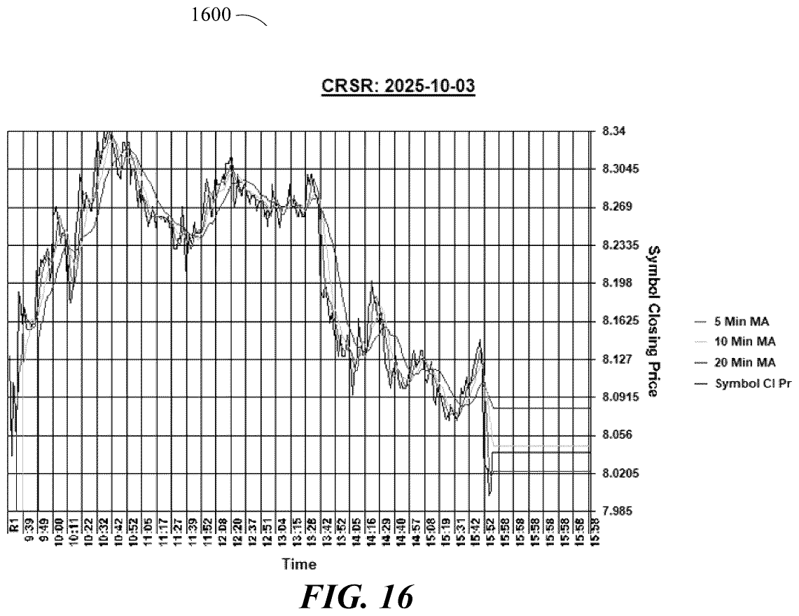

Referring to FIG. 16, the chart 1600 displays a time series of the closing price for a particular trading symbol, CRSR, identified from the RsGt20Le40 symbol set following application of a Primary Filter process as of Oct. 3, 2025. The vertical axis represents the symbol's closing price, ranging approximately from 8.20 to 8.34 USD, while the horizontal axis represents the time in minute intervals from 11:17 to 15:58. Overlaid on the price trace are three moving average lines: a 5-minute moving average, a 10-minute moving average, and a 20-minute moving average, represented by green, blue, and red traces, respectively. These moving averages provide smoothed representations of the underlying closing price data, offering insights into short-term and intermediate-term price trends and fluctuations.

The data visualized in FIG. 16 was generated as a result of applying a stepwise filtering process to the RsGt20Le40 list, isolating symbols demonstrating relatively better performance with respect to Avg % Change between Close and Low (Avg %Chg(C-L)). The plotted symbol CRSR was one of five identified by the Primary Filter for this list. As illustrated, the symbol exhibits minute-level fluctuations with intervals of price consolidation and directional movement. The alignment and divergence of the moving average lines relative to the symbol's closing price assist in visual interpretation of the symbol's intraday trend strength, support levels, and potential reversals. This figure, in combination with performance logs such as that shown in FIG. 15, facilitates a structured technical analysis workflow for evaluating how symbol-level filtering steps affect the output of candidate trading symbols, based on intraday statistical performance metrics.

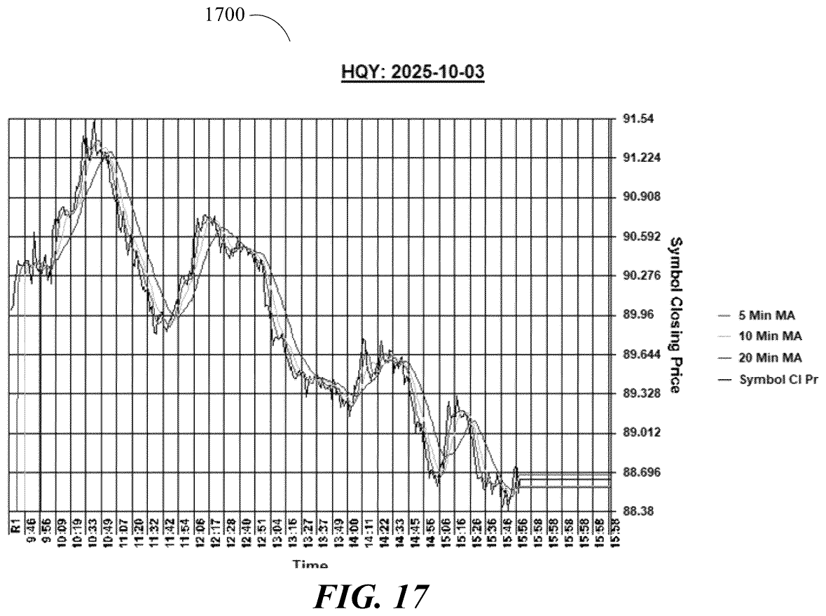

Referring to FIG. 17, the chart 1700 presents a time-series plot showing the intraday performance of a trading symbol, HQY, on Oct. 3, 2025. The horizontal axis depicts time in one-minute intervals from 9:57 AM to 3:58 PM, while the vertical axis displays the symbol's corresponding closing prices, ranging from approximately 83.86 to 91.54 USD. The plotted data reflect real-time market dynamics captured throughout the trading session. Overlaid on the raw symbol price trace are three moving average curves: a 5-minute moving average, a 10-minute moving average, and a 20-minute moving average. These are rendered in distinct line styles (green, blue, and red, respectively) and serve to visually filter noise and illustrate short-term to medium-term price trends. The alignment or divergence of the moving averages relative to the symbol's closing price assists in identifying trend shifts, momentum strength, and consolidation behavior.

The symbol HQY was one of the five securities surfaced through application of a Primary Filter to the RsGt20Le40 list. The selection process was informed by performance metrics such as the average percentage change from close to low (Avg %Chg(C-L)). As depicted in the chart, HQY experienced directional movements with intermediate consolidation phases, offering a visual representation of its suitability for short-term analysis strategies. FIG. 17, when interpreted alongside related performance logs (e.g., FIG. 15), supports a robust technical framework for understanding how quantitative filtering translates into symbol-specific price movement profiles across trading sessions. The visualization enables real-time alignment of technical analytics with symbol filtering outputs, enhancing decision-making for algorithmic or discretionary trading approaches.

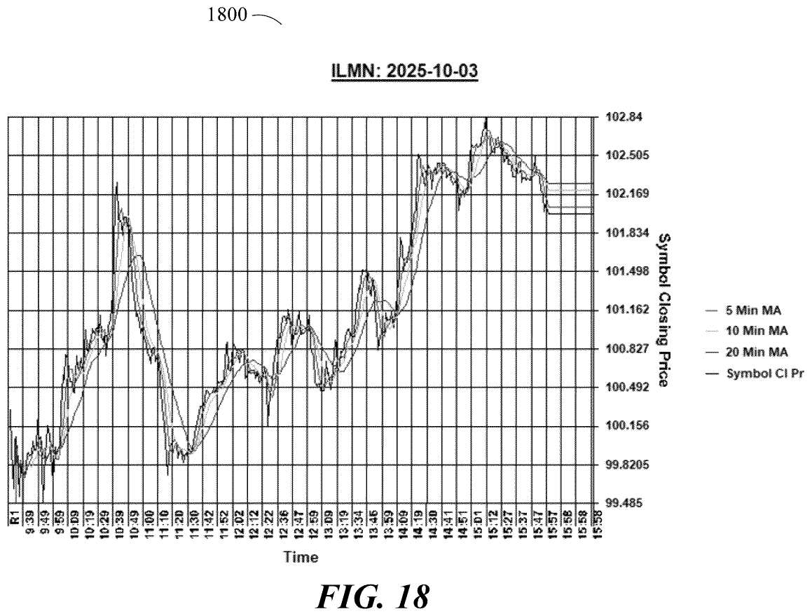

Referring to FIG. 18, the chart 1800 presents the intraday performance of the ILMN symbol over a trading window from 09:36 to 15:58 on Oct. 3, 2025. The vertical axis represents the symbol closing price, which ranges approximately from 98.45 USD to 102.34 USD. The horizontal axis represents time, marked in one-minute intervals, enabling fine-grained analysis of short-term price behavior. Superimposed on the plot of the symbol's minute-by-minute closing prices are three moving average lines. A green line corresponds to the 5-minute moving average, a blue line corresponds to the 10-minute moving average, and a red line corresponds to the 20-minute moving average. These moving averages serve to smooth short-term volatility and assist in identifying trends, inflection points, and support or resistance zones within the intraday price trajectory. The data visualized in FIG. 18 was derived from a filtering process that narrowed down a larger set of candidate symbols to a select few exhibiting improved performance metrics, such as average percentage change from close to low price (Avg %Chg(C-L)). ILMN was among the symbols identified as qualifying during a particular filter iteration, suggesting a pattern of behavior consistent with the filter's selection criteria.

Notably, ILMN's price action displays a combination of descending price segments and partial recoveries throughout the session. During several intervals, the closing price remained near or below the short-term moving averages, indicating sustained downward momentum. However, zones of moving average convergence, as seen throughout the midday session, may be indicative of consolidation or short-term equilibrium prior to further directional movement. By providing synchronized overlays of the symbol closing price and three moving average traces, FIG. 18 enables detailed technical assessment of the symbol's real-time trading characteristics. This visualization supports decision-making processes in algorithmic or manual trading workflows, allowing users to evaluate how symbols perform when selected through successive filtering operations, as described in connection with prior figures.

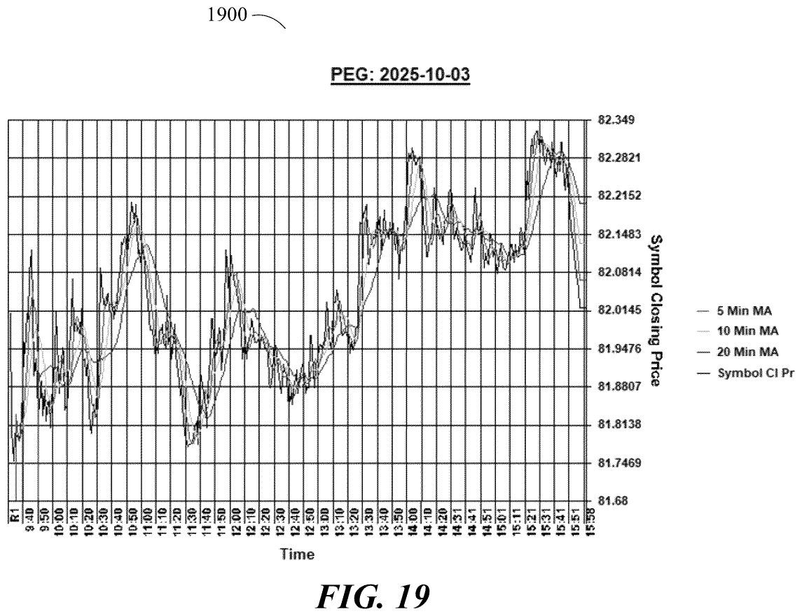

Referring to FIG. 19, chart 1900 presents a time series of minute-by-minute closing prices for the symbol PEG over the course of the trading session on Oct. 3, 2025. This symbol was identified as part of a filtered subset resulting from application of a Primary Filtering process that isolated symbols from a source set based on performance metrics such as average percentage change between the closing price and the low price (Avg %Chg(C-L)). The vertical axis of chart 1900 denotes the symbol's closing price, ranging approximately from 81.49 to 82.49 USD. The horizontal axis indicates intraday time intervals in one-minute increments from 10:01 to 15:58. The plotted data includes the actual closing price for PEG at each interval, overlaid with three trend lines representing distinct moving average periods, for example, a 5-minute moving average, a 10-minute moving average, and a 20-minute moving average. These moving average curves help characterize the underlying directional momentum and trend persistence of the price data at varying granularities.

The symbol PEG was one of five results derived from the Primary Filtering of the RsGt20Le40 symbol group. The graphical representation demonstrates real-time price fluctuations, zones of price consolidation, and regions where the closing price diverges from or converges with the respective moving average trend lines. The resulting visualization supports evaluation of the symbol's intraday volatility, trend emergence, and potential reversal zones as part of a broader technical analysis framework. Chart 1900, when considered alongside performance metrics such as those shown in FIG. 15, provides analysts and automated systems with structured and time-resolved insight into the performance trajectory of symbols selected through data-driven filtering processes. This visualization format allows for quantitative and comparative assessments of candidate symbols based on their statistical behavior and trend structure within a defined evaluation period.

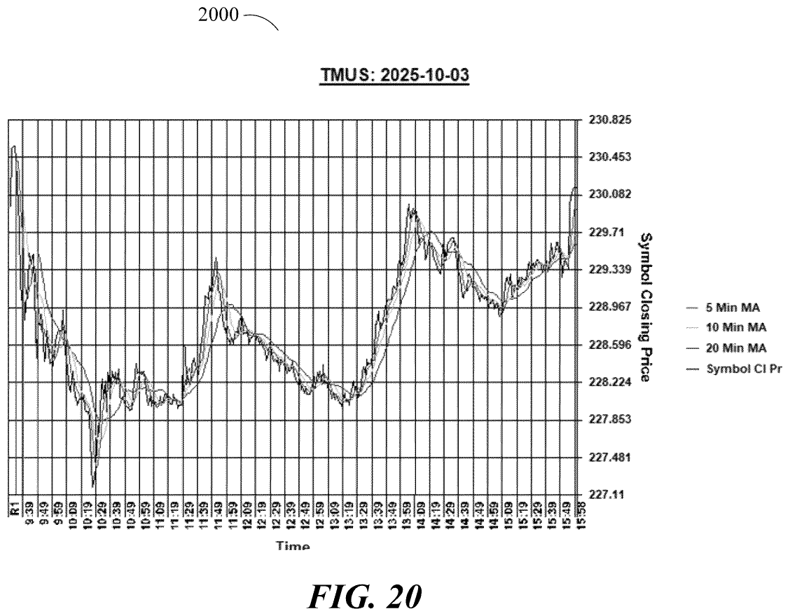

Referring to FIG. 20, chart 2000 illustrates a time-series depiction of minute-by-minute symbol closing prices for TMUS on Oct. 3, 2025. TMUS was identified as one of the top five performing symbols extracted from the RsGt20Le40 symbol list after executing the Primary Filter stage of the workflow. The vertical axis corresponds to the symbol's intraday closing price, ranging from approximately 227.41 to 230.65 USD, and the horizontal axis represents time intervals spanning from 10:00 to 15:58. Overlaid on the closing price plot are three distinct trend indicators comprising a 5-minute moving average, a 10-minute moving average, and a 20-minute moving average. These moving averages are plotted concurrently with the symbol price trace to enable technical assessment of momentum shifts, short-term price inflection points, and intermediate trend behavior.

The representation highlights the dynamic interaction between real-time price movements and smoothed average trends throughout the trading session. Observed price behavior includes upward and downward momentum phases as well as periods of consolidation. The alignment and divergence patterns of the moving averages relative to the symbol trace enable quantitative evaluation of price volatility, directional strength, and potential breakout formations. FIG. 20, when viewed in conjunction with the other symbol performance visualizations and filter logs (e.g., FIGS. 13-19), serves as a visual analytics tool for confirming the statistical merit and technical viability of symbol selections made through the system's layered filter architecture.

Referring to FIG. 21, the table 2100 displays a comparative analysis of multiple filtered symbol lists evaluated by average percent change from close to low price, designated as Avg %Ch (C-L). The vertical axis represents calendar dates across which the symbol lists performance was recorded, ranging from Sep. 26, 2025 through Oct. 3, 2025. The horizontal axis comprises a collection of symbol list types generated by various filtering criteria, including percentage-based volatility and price range indicators. Each cell in the matrix includes a numeric value reflecting the Avg %Ch (C-L) for symbols included in that list on the corresponding date. These values were generated after each list was subjected to a Primary Filtering stage. This filtering stage reduced the candidate symbols based on predefined statistical performance thresholds. Some rows contain blank cells, indicating that no qualifying symbols were returned for the corresponding list on that date, even after filtering. Shading or highlighting of individual cells visually emphasizes relative performance magnitudes, with higher Avg % Ch (C-L) values distinguished to aid rapid scanning of outlier conditions. Median values across all dates are displayed at the topmost row for comparative reference, facilitating quick identification of lists that consistently yield higher returns after filtering.

The arrows shown beneath selected column headers indicate lists empirically associated with stronger post-filtering Avg %Ch (C-L) values. While presence of these indicators does not guarantee symbol generation each trading day, historical trends shown in FIG. 21 suggest that such lists tend to produce favorable outcomes when symbols are returned. Lists that appear in both a volatility-based category and a gap-down (GD) category may yield further strategic interest for short-term trading considerations. In sum, FIG. 21 supports a data-driven strategy to select and monitor symbol lists for short-term trading, based on observed performance of filtered symbols using the Avg %Ch (C-L) metric. This chart provides a foundation for refining symbol list selection criteria within a broader filtering and trading methodology.

The disclosed methods provide a computer-implemented system and process for dynamically generating, organizing, and filtering symbol-based financial datasets using rule-based transformations of market data. The system improves the functionality of electronic financial analysis platforms by enabling automated generation of categorized symbol files based on percent changes in price and volume. In particular, a processor executes instructions stored in non-transitory memory to perform operations on time-stamped market data, such as retrieving closing price values, computing price change values from a defined historical baseline, and calculating a percent price change using a normalized formula: PercentPriceChange=(PriceChange÷Price)×100. The processor then classifies each financial instrument symbol into one of multiple threshold-based categories by applying conditional logic on the computed PercentPriceChange value. If the value exceeds 20 and is less than or equal to 30, the symbol is inserted into a first structured data output file. If the value exceeds 30 and is less than or equal to 40, the symbol is directed to a second structured output file. If the value exceeds 40 and is less than or equal to 100, the symbol is added to a third output file. Each file is created in a predefined comma-separated value (CSV) format and serves as a dynamically generated output record for use in downstream filtering and spreadsheet visualization.

The system also processes volume-based changes to detect abnormally high trading activity, which may serve as a proxy for significant market behavior. For this purpose, a second processor routine executes logic for classifying the volume change (VolChange) of each financial symbol. If the detected volume change exceeds 800 and is less than or equal to 1600, the symbol is recorded into a corresponding output file. Similarly, if the volume change exceeds 1600 and is less than or equal to 3200, the symbol is routed to a different output file, and if the volume change exceeds 3200, the symbol is inserted into a third output file. These thresholds are not arbitrary, but are derived from statistical analysis of historical volume distributions and are implemented as discrete binning categories. The use of discrete, file-separated outputs rather than a monolithic record improves data indexing efficiency and reduces the computational load during subsequent filtering steps.

The source data for price and volume metrics is obtained from structured electronic databases accessible via public or subscription-based financial information platforms such as IBD's MarketSurge or similar financial data providers. The system integrates these external sources through data ingestion modules and performs transformation operations within a rule-based filtering engine. The resulting outputs are not only human-readable but also formatted to support direct ingestion into downstream analytical systems, spreadsheet software, or trading support platforms. Furthermore, the architecture of the system enables automated daily regeneration of these files using batch or scheduled routines, enhancing repeatability and reliability while minimizing human intervention.

In contrast to conventional manual financial screening methods, the present system provides a technological improvement in the field of financial data analysis by using automated, rule-based symbol categorization through software-controlled operations that execute on structured datasets. The process as a whole cannot be performed as a mental process because it involves the generation of multiple output files, integration with external APIs or data sources, and structured formatting for machine readability. By improving the accuracy, speed, and repeatability of symbol classification for trading decision support, the claimed invention provides a technical solution to a technical problem, for example, the need for scalable and responsive methods for financial signal detection across large and evolving datasets.

In some embodiments, FIG. 22 depicts a computing interface 2200 that automates the process of testing the performance of symbol lists generated through Primary Filtering. The system performs this process by identifying symbols that appear in multiple lists, up to six, and applying the filtering operation for each test day within a selected historical range. This interface enables a user to specify parameters for test execution, such as the date range, symbol list combinations, and the logic for intersection of symbols across lists. Once the symbols have been filtered for each test day, the system computes two key performance metrics across the historical testing period: (i) the average percentage change from daily close to low price for the filtered symbols (“Avg %Ch (Close-Low)”) and (ii) the maximum percentage change from close to low for the top-performing symbol on each test day (“Max %Ch (Close-Low)”). The lower portion of the form displays tabular results of the calculated metrics for each test day, including dates, symbol identifiers, and associated percentage change values. These values are collected and summarized over a large number of test days, such as a 1,000-day testing window.

To aid visual analysis, two bar charts are generated. The upper chart provides a distribution of the Avg %Ch (Close-Low) metric over the entire testing period. The lower chart illustrates the distribution of the Max %Ch (Close-Low) values. Both charts include an overlaid cumulative sum line, allowing users to observe aggregate behavior over time and to evaluate the consistency and reliability of performance for each tested symbol list combination. The system and method implemented through this interface improve computer functionality by reducing the manual effort required to perform repeated filtering and evaluation steps over historical financial data. Moreover, the implementation allows for dynamic testing of various list intersections and supports automated generation of performance visualizations for informed decision-making in symbol selection. Such features provide improvements in both computational efficiency and usability within the technical field of data-driven financial symbol screening. The disclosed system and methods provide substantial technical improvements to computerized financial data analysis by automating the selection, filtering, and performance evaluation of symbol list combinations across extended historical datasets. Rather than requiring manual data entry and analysis for each trading day, the system employs programmed logic to identify intersecting symbols across multiple lists and to perform Primary Filtering operations over large temporal ranges (e.g., 1,000 test days). This automation results in faster, more accurate symbol screening, and reduces the computational overhead associated with user-driven iterative back testing.

The form-based user interface operates in conjunction with underlying data structures and stored procedures to enable dynamic configuration of testing parameters. By automatically calculating and aggregating percentage change metrics (e.g., average and maximum close-to-low deltas) over selected days, the system materially improves the efficiency and reliability of evaluating symbol list performance. Furthermore, the generation of visual plots with overlaid cumulative functions allows users to identify statistically significant patterns that would not be readily discoverable through conventional spreadsheet review, thereby enhancing the user's ability to make timely trading decisions based on historical symbol behavior. These improvements are not merely abstract ideas but are instead rooted in specific technological enhancements to the way financial datasets are filtered, transformed, and visualized on computing systems. The features, including automated intersection of symbol lists, real-time filtering logic across multi-day historical data, metric computation, and integrated visual feedback, improve computer functionality and transform the computer into a more efficient tool for symbol selection analysis. The system is not merely performing a mental process or generic financial calculation; it is executing specific, structured data operations through a novel and practical interface that allows users to derive actionable insights from large-scale historical data with minimal manual intervention.

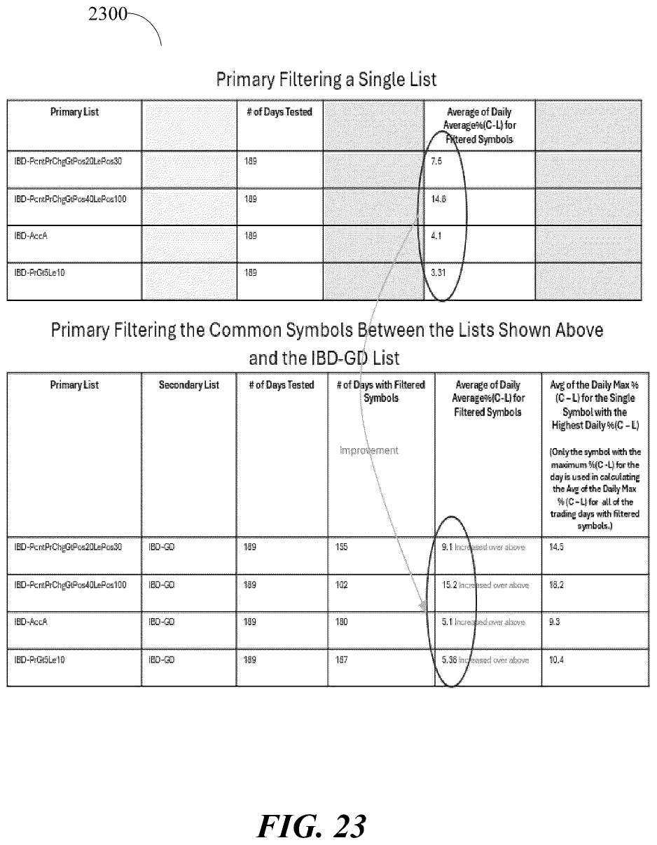

FIG. 23 presents tabulated results comparing two filtering techniques applied to financial symbol lists over a fixed number of days (189 test days). The upper table displays the performance of primary filtering applied to four different individual symbol lists. Each row of the upper table includes the name of the primary list, the number of test days, and a calculated average of the daily percentage change from closing price to low price (Avg %Ch (C-L)) for the filtered symbols. The values in the rightmost column indicate that some individual lists (e.g., “IBD-PcntChgDn5PcntUp5Pcnt10”) produce significantly higher Avg %Ch (C-L) values than others when used alone.

The lower table in FIG. 23 presents a performance analysis of filtering symbols that appear in both a selected primary list and a secondary list labeled “IBD-GD.” This additional filtering layer identifies only the symbols common to both lists for each trading day. For each pairing of primary and secondary lists, the table shows: the number of test days, the number of days that produced filtered symbols, the average daily percentage change from closing price to low price for the filtered symbols, and the average of the maximum daily percentage change from closing price to low price for the highest-performing symbol per day.

The data demonstrate consistent performance improvements when filtering for symbols that are common to both a selected list and the IBD-GD list, as indicated by increases in the average values of daily minimum price excursions from the close. For example, the combination of “IBD-PentChgDn5PcntUp5Pcnt20” with the IBD-GD list yields an average of 9.1 percent change from close to low, compared to 7.6 percent when using the primary list alone. This supports the effectiveness of composite list intersection techniques to identify higher-performing financial symbols for downstream decision-making processes such as trade execution, predictive modeling, or portfolio management. Each cell in the table is the result of empirical back testing performed using a structured test protocol, and the figures reflect numeric performance improvements achieved through strategic list combinations. These improvements illustrate the technical effect of narrowing and refining symbol selection through comparative filtering, which may be implemented in automated trading tools, analytics dashboards, or decision-support systems.

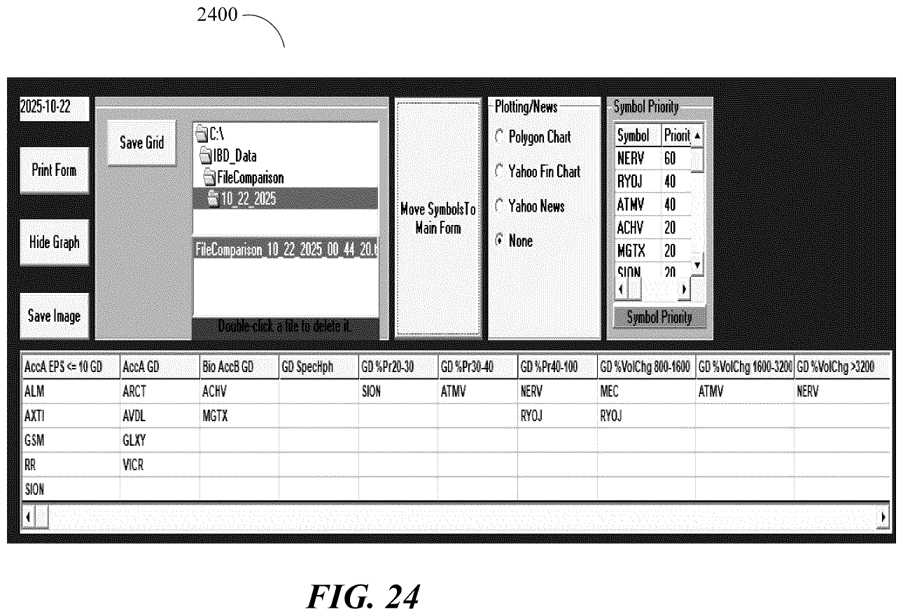

Referring to FIG. 24, illustrated is a graphical user interface (UI) display 2400 generated by a computing system configured to execute daily symbol filtering operations based on a plurality of user-defined symbol lists. The system receives symbol data from multiple input lists, applies a Primary Filtering process based on predefined filters and percentage change criteria, and outputs a set of candidate symbols for user consideration in day trading or investment decision-making workflows. The display includes a section for selecting the target filtering date (e.g., “12_12_2025”) and associated options for storage or graphical display. The left-hand panel shows configurable filtering menus, which allow the user to define input symbol sources and specify list combinations for inclusion in the filtering operation. Examples of selectable sources include “Playroom Check1”, “Custom Track1”, and others, and users can specify symbols manually or from linked data structures.

In the center panel, a list of symbol filtering priorities is displayed, which includes ranked lists of securities or financial instruments, each derived from list intersections. Each column heading corresponds to a unique symbol list combination (e.g., “IBD-GD+GDVolChgPosAccUp >800”, “GDAcc+GD”, etc.). The rows beneath each header display ticker symbols (e.g., “AVAV,” “RDU,” “SON”) that meet Primary Filtering criteria for the specified list combination on the selected trading day. Symbols appearing in more than one column are prioritized for trading consideration due to their overlap across multiple signal-generating criteria. This intersection-based prioritization enables traders to identify high-confluence candidates likely to exhibit stronger trading potential. In some embodiments, these overlapping symbols are automatically ranked or visually highlighted for the user.

The display interface optionally includes control buttons to “Print Form,” “Hide Graph,” or “Save Image,” supporting export and review of filtered results for historical tracking, report generation, or manual analysis. This enables users to preserve daily outputs from the symbol filtering logic for ongoing performance review or for integration into automated trading workflows. By structuring the data presentation around symbol intersections between multiple lists, this embodiment enhances the user's ability to detect convergence signals and prioritize candidates that have passed through multiple independent filtering pipelines, thereby improving actionable insight extraction for each trading day.

### EXAMPLES

### Embodiment 1

A computer-implemented method for identifying high-performing stock symbol lists for targeted trading, the method comprising: retrieving, by a computing system comprising at least one processor, a non-transitory memory, and a graphical user interface, one or more predefined stock symbol lists, each predefined stock symbol list comprising a set of unique stock identifiers; for each of the one or more predefined stock symbol lists, executing, by the at least one processor, a primary filtering process to generate a corresponding post-filtered subset of stock symbols that satisfy one or more predefined selection criteria based on price and/or volume characteristics; computing, by the at least one processor, one or more aggregate performance metrics for each post-filtered subset over a plurality of trading days; ranking, by the at least one processor, the one or more predefined stock symbol lists based on the aggregate performance metrics using a stored ranking algorithm; and displaying, via the graphical user interface, a ranked set of the predefined stock symbol lists with corresponding visual representations of performance distributions, wherein the method improves computing system performance by reducing processor load, memory usage, and display rendering operations through automated exclusion of underperforming symbol lists prior to visualization or user interaction, wherein ranking the one or more predefined symbol lists using the performance metrics facilitates dimensionality reduction and early-stage pruning, thereby optimizing CPU thread allocation and cache usage during batch filtering operations.

### Embodiment 2

The method of embodiment 1, wherein the visual representations comprise a distribution plot for each of the ranked set of the predefined stock symbol lists.

### Embodiment 3

The method of embodiment 2, wherein each distribution plot includes a cumulative line plot representing a running sum of distribution values.

### Embodiment 4

The method of embodiment 3, wherein the cumulative line plots for multiple of the ranked set of the predefined stock symbol lists are concurrently displayed on a single canvas of the graphical user interface, thereby reducing DOM tree complexity and graphical processing unit (GPU) workload during concurrent display of symbol list performance data.

### Embodiment 5

The method of embodiment 1, wherein the predefined selection criteria include a range of percentage-based price changes, a range of percentage-based volume changes, or a combination thereof.

### Embodiment 6

The method of embodiment 5, wherein the range of percentage-based price changes includes one or more of: greater than twenty percent and less than or equal to thirty percent, greater than thirty percent and less than or equal to forty percent, or greater than forty percent and less than or equal to one hundred percent.

### Embodiment 7

The method of embodiment 5, wherein the range of percentage-based volume changes includes one or more of: greater than eight hundred and less than or equal to sixteen hundred, greater than sixteen hundred and less than or equal to thirty-two hundred, or greater than thirty-two hundred.

### Embodiment 8

The method of embodiment 1, wherein the aggregate performance metrics for each post-filtered subset are calculated across at least two hundred fifty trading days.

### Embodiment 9

The method of embodiment 1, wherein the primary filtering process for each of the plurality of predefined stock symbol lists is constrained to produce a maximum number of stock symbols in the corresponding post-filtered subset.

### Embodiment 10

The method of embodiment 1, further comprising identifying, by the at least one processor, one or more stock symbols that are present in both a post-filtered subset and a predefined global dataset, and prioritizing display of the identified stock symbols via the graphical user interface.

### Embodiment 11

The method of embodiment 1, wherein the aggregate performance metrics comprise one or more of: historical volatility, daily price fluctuation magnitude, or directional price shift magnitude.

### Embodiment 12

The method of embodiment 1, further comprising generating, by the at least one processor, a bar chart visualization including values associated with performance metrics for each of the post-filtered subsets.

### Embodiment 13

The method of embodiment 1, further comprising executing, by the at least one processor, an automated backtest module that evaluates the performance metrics for each of the predefined stock symbol lists across historical trading days.

### Embodiment 14

The method of embodiment 13, further comprising generating, by the at least one processor, a visual summary of the backtest module results, the visual summary comprising a range distribution plot and a maximum value indicator for each of the predefined stock symbol lists.

### Embodiment 15

The method of embodiment 1, wherein the ranked set of the predefined stock symbol lists is refreshed daily based on updated market data received via a financial data feed; and wherein symbol list ranking is performed server-side and only top-tier visualization data is transmitted to a client device, thereby minimizing network bandwidth usage and improving interface responsiveness.

### Embodiment 16

The method of embodiment 1, further comprising dynamically selecting, by the at least one processor, the predefined stock symbol lists for ranking based on presence of overlap with one or more user-defined lists.

### Embodiment 17

The method of embodiment 1, wherein the at least one processor receives market data from one or more external public data feeds comprising end-of-day price and volume information.

### Embodiment 18

The method of embodiment 1, wherein the graphical user interface displays the ranked set of the predefined stock symbol lists in visual priority order to reduce decision latency and minimize interface congestion.

### Embodiment 19

A system for filtering, ranking, and displaying high-performing stock symbol lists for trading, the system comprising: a data interface configured to retrieve price and volume data for a plurality of stock symbols from one or more external data sources; a non-transitory memory storing: a plurality of predefined stock symbol lists, each comprising unique stock identifiers, one or more selection criteria, and program instructions for filtering and ranking operations; at least one processor configured to execute the program instructions to: apply a primary filtering operation to each of the predefined stock symbol lists to generate a corresponding post-filtered subset; compute aggregate performance metrics for each of the post-filtered subsets; rank the predefined stock symbol lists based on the aggregate performance metrics; and generate display data comprising visualizations of the ranked predefined stock symbol lists; and a graphical user interface configured to render the display data for user review, wherein the system reduces unnecessary data processing and graphical rendering overhead by excluding underperforming symbol lists prior to output generation.

### Embodiment 20

The system of embodiment 19, wherein the at least one processor is further configured to execute an automated backtest engine that analyzes symbol list combinations across a range of trading days and outputs a performance summary for display on the graphical user interface.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer-readable instructions are provided to the processor 334 of a general purpose computer, special purpose computer, or other programmable data processing apparatus (e.g., the computing device 336) to produce a machine, such that the instructions, which execute via the processor 334 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 336), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

In certain embodiments, the apparatus and methods delineated above find application within a system comprising one or more integrated circuit (IC) devices, also referred to as integrated circuit packages or microchips, akin to the previously described processing system. Electronic design automation (EDA) and computer-aided design (CAD) software tools facilitate the design and fabrication of these IC devices. Typically, these design tools manifest as one or more software programs, comprising executable code designed to manipulate a computer system. Such manipulation involves the processing of code representative of circuitry within one or more IC devices, thereby executing at least a portion of a process aimed at designing or adapting a manufacturing system for fabricating said circuitry. This code encompasses instructions, data, or a combination thereof, and is stored in a computer-readable storage medium accessible to the computing system. The code representative of various design or fabrication phases may be stored and accessed from the same or different computer-readable storage media.

A computer-readable storage medium encompasses any non-transitory medium or combination thereof accessible by a computer system during operation to furnish instructions and/or data. These media include optical media (e.g., CDs, DVDs, Blu-Ray discs), magnetic media (e.g., floppy discs, magnetic tape, magnetic hard drives), volatile memory (e.g., RAM, cache), non-volatile memory (e.g., ROM, Flash memory), or microelectromechanical systems (MEMS)-based storage media. Such media may be embedded, fixedly attached, or removably attached to the computing system, or coupled to it via a wired or wireless network.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A computer-implemented method for identifying high-performing stock symbol lists for targeted trading, the method comprising:
retrieving, by a computing system comprising at least one processor, a non-transitory memory, and a graphical user interface, one or more predefined stock symbol lists, each predefined stock symbol list comprising a set of unique stock identifiers;
for each of the one or more predefined stock symbol lists, executing, by the at least one processor, a primary filtering process to generate a corresponding post-filtered subset of stock symbols that satisfy one or more predefined selection criteria based on price and/or volume characteristics;
computing, by the at least one processor, one or more aggregate performance metrics for each post-filtered subset over a plurality of trading days;
ranking, by the at least one processor, the one or more predefined stock symbol lists based on the aggregate performance metrics using a stored ranking algorithm; and
displaying, via the graphical user interface, a ranked set of the predefined stock symbol lists with corresponding visual representations of performance distributions,
wherein the method improves computing system performance by reducing processor load, memory usage, and display rendering operations through automated exclusion of underperforming symbol lists prior to visualization or user interaction,
wherein ranking the one or more predefined symbol lists using the performance metrics facilitates dimensionality reduction and early-stage pruning, thereby optimizing CPU thread allocation and cache usage during batch filtering operations.

2. The method of claim 1, wherein the visual representations comprise a distribution plot for each of the ranked set of the predefined stock symbol lists.

3. The method of claim 2, wherein each distribution plot includes a cumulative line plot representing a running sum of distribution values.

4. The method of claim 3, wherein the cumulative line plots for multiple of the ranked set of the predefined stock symbol lists are concurrently displayed on a single canvas of the graphical user interface, thereby reducing DOM tree complexity and graphical processing unit (GPU) workload during concurrent display of symbol list performance data.

5. The method of claim 1, wherein the predefined selection criteria include a range of percentage-based price changes, a range of percentage-based volume changes, or a combination thereof.

6. The method of claim 5, wherein the range of percentage-based price changes includes one or more of:
about 20% to about 30%,
about 30% to about 40%, or
about 40% to about 100%.

7. The method of claim 5, wherein the range of percentage-based volume changes includes one or more of:
about 800% to about 1600%,
about 1600% to about 3200%, or
greater than about 3200%.

8. The method of claim 1, wherein the aggregate performance metrics for each post-filtered subset are calculated across at least two hundred fifty trading days.

9. The method of claim 1, wherein the primary filtering process for each of the plurality of predefined stock symbol lists is constrained to produce a maximum number of stock symbols in the corresponding post-filtered subset.

10. The method of claim 1, further comprising identifying, by the at least one processor, one or more stock symbols that are present in both a post-filtered subset and a predefined global dataset, and prioritizing display of the identified stock symbols via the graphical user interface.

11. The method of claim 1, wherein the aggregate performance metrics comprise one or more of:
historical volatility, daily price fluctuation magnitude, or directional price shift magnitude.

12. The method of claim 1, further comprising generating, by the at least one processor, a bar chart visualization including values associated with performance metrics for each of the post-filtered subsets.

13. The method of claim 1, further comprising executing, by the at least one processor, an automated backtest module that evaluates the performance metrics for each of the predefined stock symbol lists across historical trading days.

14. The method of claim 13, further comprising generating, by the at least one processor, a visual summary of the backtest module results, the visual summary comprising a range distribution plot and a maximum value indicator for each of the predefined stock symbol lists.

15. The method of claim 1, wherein the ranked set of the predefined stock symbol lists is refreshed daily based on updated market data received via a financial data feed; and
wherein symbol list ranking is performed server-side and only top-tier visualization data is transmitted to a client device, thereby minimizing network bandwidth usage and improving interface responsiveness.

16. The method of claim 1, further comprising dynamically selecting, by the at least one processor, the predefined stock symbol lists for ranking based on presence of overlap with one or more user-defined lists.

17. The method of claim 1, wherein the at least one processor receives market data from one or more external public data feeds comprising end-of-day price and volume information.

18. The method of claim 1, wherein the graphical user interface displays the ranked set of the predefined stock symbol lists in visual priority order to reduce decision latency and minimize interface congestion.

19. A system for filtering, ranking, and displaying high-performing stock symbol lists for trading, the system comprising:
a data interface configured to retrieve price and volume data for a plurality of stock symbols from one or more external data sources;
a non-transitory memory storing:
one or more predefined stock symbol lists, each comprising one or more unique stock identifiers,
one or more selection criteria, and
program instructions for filtering and ranking operations;
at least one processor configured to execute the program instructions to:
apply a primary filtering operation to each of the predefined stock symbol lists to generate a corresponding post-filtered subset;
compute aggregate performance metrics for each of the post-filtered subsets;
rank the predefined stock symbol lists based on the aggregate performance metrics; and
generate display data comprising visualizations of the ranked predefined stock symbol lists; and
a graphical user interface configured to render the display data for user review,
wherein the system reduces unnecessary data processing and graphical rendering overhead by excluding underperforming symbol lists prior to output generation.

20. The system of claim 19, wherein the at least one processor is further configured to execute an automated backtest engine that analyzes one or more symbol list combinations across a range of trading days and outputs a performance summary for display on the graphical user interface.
